(19) United States
(12) Patent Application Publication
(10) Pub. No.: US 2011/0283232 A1
(43) Pub. Date: Nov. 17, 2011

(54) USER INTERFACE FOR PUBLIC AND PERSONAL CONTENT BROWSING AND SELECTION IN A CONTENT SYSTEM

(75) Inventors: David Jordan, San Francisco, CA (US); Paul T. Stathacopoulos, San Carlos, CA (US); Thomas Steven Woods, Arlington Heights, IL (US); Brian Peterson, Barrington, IL (US); Jason Conness, Los Angeles, CA (US); Gaurav Sinha, Irvine, CA (US); China Arai, Valley Glen, CA (US); Gareth Dean White, Walnut Creek, CA (US); Kim Rubric Dykeman, San Francisco, CA (US); Trent Wheeler, Berkeley, CA (US); Daniel Wright Trenz, Ann Arbor, MI (US); Christopher Dow, Palo Alto, CA (US)

(73) Assignee: Rovi Technologies Corporation, Santa Clara, CA (US)

(21) Appl. No.: 13/049,261

(22) Filed: Mar. 16, 2011

Related U.S. Application Data
(60) Provisional application No. 61/345,813, filed on May 18, 2010.
(60) Provisional application No. 61/345,877, filed on May 18, 2010.
(60) Provisional application No. 61/345,030, filed on May 14, 2010.

(51) Int. Cl. G06F 3/048

(52) U.S. Cl. 715/810

(57) ABSTRACT

A computer-implemented system and method providing a user interface for content browsing and selection in a content system. Embodiments include: gathering available content information related to a plurality of content items from a plurality of content sources via a data network, the plurality of content sources including a public content source and a personal content source; processing the content information, using a processor, to provide digital representations of the plurality of content items, the digital representations including a digital representation of a public content item from the public content source and a digital representation of a personal content item from the personal content source; and displaying available content information related to the selected content item in response to receiving a selection of the content item, the available content information including at least one user-selectable command option for obtaining an additional level of detailed information related to the selected content item.

### PRIORITY APPLICATIONS

This patent application claims the benefit of the filing date of U.S. Provisional Patent Application Ser. No. 61/345,813, filed May 18, 2010, by the same assignee, which is hereby incorporated by reference in its entirety.

This patent application claims the benefit of the filing date of U.S. Provisional Patent Application Ser. No. 61/345,877, filed May 18, 2010, by the same assignee, which is hereby incorporated by reference in its entirety.

This patent application claims the benefit of the filing date of U.S. Provisional Patent Application Ser. No. 61/346,030, filed May 18, 2010, by the same assignee, which is hereby incorporated by reference in its entirety.

### COPYRIGHT NOTICE

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2008-2010, Macrovision Solutions Corporation and Rovi Corporation, All Rights Reserved.

### BACKGROUND

1. Technical Field

This disclosure relates to networked systems. More particularly, the present disclosure relates to networked content systems.

2. Related Art

In conventional content aggregation and delivery systems, it can be difficult to manage content for playback on a particular client playback device when there are multiple playback devices, multiple playback device types, multiple content sources, and multiple instances (copies) of a particular desired item of content. Typically, electronic program guides (EPG's) or interactive program guides (IPG's) were provided to allow a viewer and/or user to browse available programming. However, in conventional program guides, data was only available to devices through broadcast channels. In updated conventional program guides, the guides also support delivery of data over the Internet, but that delivered data is the same data as what is broadcast.

Well-known web surfing technology enables a computer user to navigate through a series of hyperlinks provided on web pages to drill into the topics of information that may suit their interest. Although web surfing provides a convenient way to obtain information available on data network, web surfing is not well suited for selecting among an array of content items for viewing or listening to content on consumer electronics (CE) devices.

Consumers have traditionally used CE devices to scan the sequential channel programming or time period selections by using a remote device and a television viewing monitor or audio device. Though some information on particular content items can be viewed or heard in a conventional system, the consumer is limited to selecting from one of the sequential programming channel options.

Thus, a computer-implemented system and method for providing a user interface for content browsing and selection in a content system is needed.

### BRIEF DESCRIPTION OF THE DRAWINGS

Embodiments are illustrated by way of example and not limitation in the figures of the accompanying drawings, in which:

FIG. 1 illustrates an example architecture for delivering content to a user of a user platform, according to various embodiments;

FIG. 2 illustrates an architecture for delivering content and/or content information to a user platform, according to various embodiments;

FIG. 3 illustrates a service provider for delivering content to a user of a user platform, according to various embodiments;

FIG. 4 is a flow diagram illustrating a method of delivering content to a user of a user platform, according to various embodiments;

FIG. 5 illustrates a process for registering a user and/or a user platform with a content source;

FIG. 6 illustrates an example user platform, according to various embodiments;

FIG. 7 illustrates an example architecture for a networked browsing and/or recommendation architecture within which various embodiments operate;

FIG. 8 illustrates a set of example platform services supported by an example cross-platform service component of a particular embodiment and a set of source services provided by the content sources;

FIG. 9 illustrates a user platform according to an example embodiment;

FIG. 10 illustrates an example environment showing an example data connection between the user platform and the cross platform services component;

FIG. 11 illustrates a user platform data delivery component for a user platform of an implementation;

FIG. 12 illustrates the factors used in an example embodiment to fill the content information cache in a user platform according to an example embodiment;

FIG. 13 illustrates a user platform according to an example embodiment, wherein the example user platform includes components for data delivery, according to an embodiment;

FIG. 14 illustrates an alternative implementation of a user platform according to another example embodiment, wherein the example user platform includes components for content integration by using custom integration applications on the user platform, according to an embodiment;

FIGS. 15-16 illustrate a sequence of processing operations in example embodiments;

FIGS. 17-38 illustrate various example interfaces of a sample content browsing and selection user interface provided in an example embodiment;

FIG. 39 illustrates a sequence of processing operations in an example embodiment; and

FIG. 40 shows a diagrammatic representation of a machine in the form of a computer system within which a set of instructions, for causing the machine to perform any one or more of the methodologies discussed herein, may be executed, according to an example embodiment.

### DETAILED DESCRIPTION

A computer-implemented method, system, and apparatus for providing a user interface for content browsing and selection in a content system are disclosed. In the following description, numerous specific details are set forth. However, it is understood that embodiments may be practiced without these specific details. In other instances, well-known processes, structures and techniques have not been shown in detail in order not to obscure the clarity of this description. Various embodiments are described below in connection with the figures provided herein.

### OVERVIEW OF VARIOUS EMBODIMENTS

The various embodiments described herein are part of a content browsing and recommendation system that includes an enhanced interactive and/or electronic program/programming guide (IPG and/or EPG) and a content integration system. The various embodiments provide a rich content browsing and recommendation experience, which utilizes host site databases to correlate content across delivery media, such as linear television, internet-based video on demand services, recorded content, and content available on the home network. In conventional program guides, data is only available to devices through broadcast channels. In updated conventional program guides, the guides also support delivery of data over the Internet, but that delivered data is the same data as what is broadcast.

Within this document, content includes television programming, movies, music, spoken audio, games, images, special features, scheduled and unscheduled media, on-demand and/or pay-per-view media, and further includes broadcast, multicast, downloaded, streamed media, and/or media or content that is delivered by another means. The content as described herein can include publicly-available content, such as the content access sold by commercial publishers, broadcasters, networks, record labels, media distributors, web-sites, and the like. The content as described herein can also include private or personal content, such as personal content libraries, playlists, personal movie, music, or photo libraries, private text libraries, personal mix recordings, originally recorded content, and the like. As described herein, the term, “content” is distinguished from the term, “content information” that is related to, but separate from the content itself. The term “content information,” which may include metadata, refers to information associated with or related to one or more items of content and may include information used to access the content. The content information, provided and/or delivered by various embodiments, is designed to meet the needs of the user in providing a rich media metadata browsing experience. The content information also includes guide data, listings data and program information, in addition to extended metadata, such as MyTV™ module metadata, celebrity biographies, program and celebrity images, and the like for channel lineups and other media and/or content sources that are available to the end user at the user's location. A MyTV™ module is provided by the Microsoft™ Media Center system to view live TV broadcast programming and/or to view a program guide of available broadcast programming. As described herein, guide data can be used to generate a content guide that can be used to display available programming options, sources of the programming, and temporal information for the available programming options to enable a user to browse, search, select, and view/consume a desired programming option.

Unfortunately, because there are so many available content sources and so much available information for each content source, the volume of data in the available content information can overwhelm a network's ability to transfer the data and a user platform's ability to receive, process, and display the content information on a sufficiently frequent basis. Without effective management of the data delivery and consumption by a user platform, it is effectively impossible for all the content information to be packaged up and delivered on a sufficiently frequent basis to all user platforms; because the content information includes so many content sources other than conventional linear television. This situation leads to two conclusions:
1. A host site must provide an internet-based service that can provide selected content information to all deployed user platforms in real time.
2. The existence of such a service allows the host site to radically reduce the amount of content information packaged and delivered to user platforms in bulk on a scheduled, e.g., daily, basis.

The various embodiments described herein provide an architecture that allows a host site to package and bulk deliver content information and content itself to user platforms, wherein the content information contains only the content listings and/or program guide for the channel line-up for which the user has indicated a use or preference. Additionally, the various embodiments described herein provide an architecture that allows a host site to package and deliver content information in real-time to user platforms based on a user content selection or preference. The content itself can be delivered to a user platform via a content integration system described herein.

Within this document, the term “user” includes a viewer of television and/or video content as well as a consumer of other content. In the various embodiments described herein, the user platform can fetch content information, including extended metadata, extended program information, celebrity information such as biographies, images, trailers, and the like, that the user platform needs based on the usage of the user platform by a user. In two example embodiments described herein, there are at least two methods for delivering required and/or requested content information to a user platform. The first method is to fill a local user platform content information cache with content information at off-peak times. The second method, employed when the user needs content information that is not in the local cache, is to get the content information by using host site services in real time. In a particular embodiment, a host site can use a cross-platform service (CPS) component and real-time services in both cases. Other equivalent embodiments can be implemented without cross-platform services. These methods and services are described in more detail below.

Some example embodiments described herein also include a system and method for delivering content to a user of a registered user platform. Assets retrieved from a number of content sources may be stored in a database at a service provider or the content itself can be retained at the content source for direct delivery to a user platform as described in more detail herein. The term “asset” can be taken to include, but is not limited to, one or more collections of content, content information and metadata associated with the content, e.g., descriptions, synopses, biographies, trailers, reviews, links, etc., and content source catalogs. Each asset can contain a content item and content information related to the content item. Content information related to a number of content items retrieved from the assets may be presented to the user of the registered user platform. In response to a request from the user, a content item associated with a content source may be delivered directly to the user platform without a need for explicit user authentication. The service provider may authenticate on behalf of the user so that the user does not need to be asked to authenticate each time the user employs the registered user platform to order content from the content source.

In example embodiments, the content may comprise, but is not limited to, digital content including electronic publications such as electronic books, journals, newspapers, catalogs, and advertisements, and multimedia content including audio and video content. Content sources are originators, providers, publishers, and/or broadcasters of such content and assets. Content sources can be conventional television or radio broadcasters, Internet sites, printed media authors or publishers, magnetic or optical media creators or publishers, and the like.

A registered user platform, e.g., a registered user device or a set of user devices, may comprise a consumer electronic (CE) device including additional hardware and software that enables the consumer electronic device to register with a service provider. Some consumer electronic devices, such as television sets, may enable access to the Internet by being coupled to a computer, e.g., a personal computer (PC) such as a laptop or a desktop computer, etc. The registered consumer electronic device may be used by a user to access content from various content sources such as, for example, Amazon, Netflix, Napster, CBS, etc., over the Internet, directly without connection through a computer, as discussed in detail below.

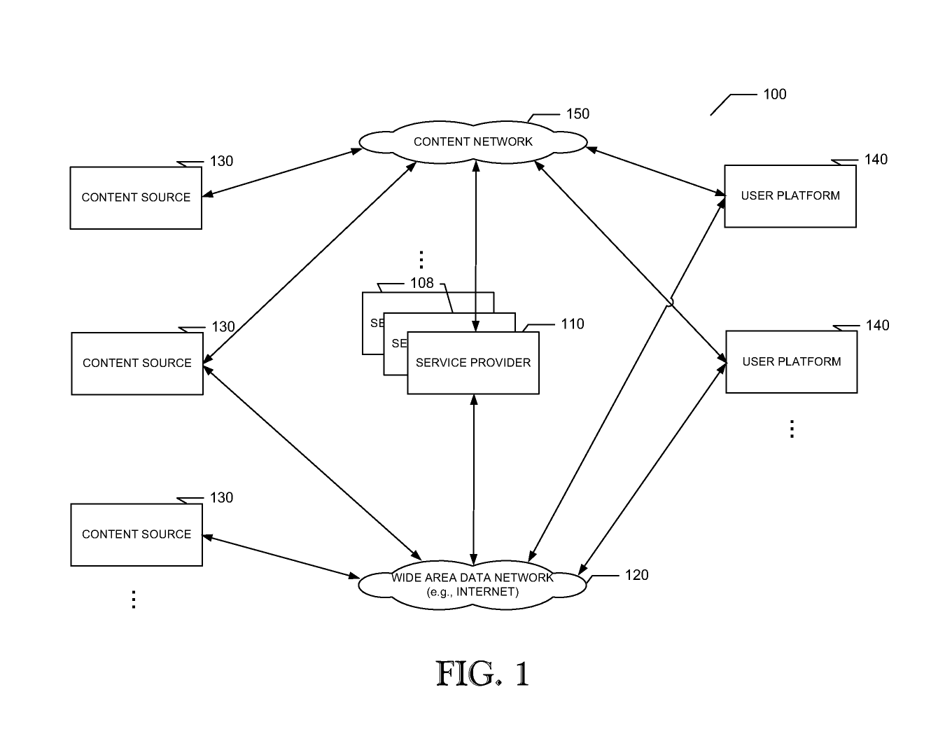

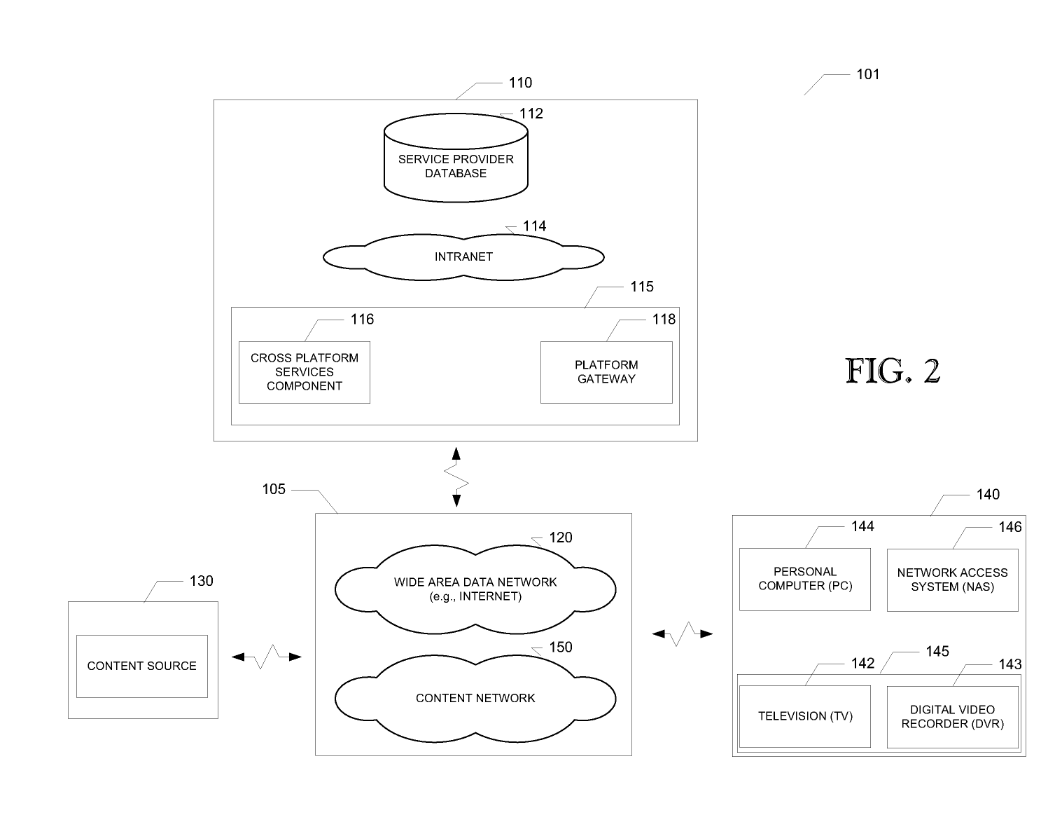

FIGS. 1 and 2 illustrate example architectures 100 and 101 for delivering content and content information to a user of a user platform 140, according to various embodiments. Preferably, the user platform 140 receiving the content and/or content information comprises a registered user platform. Registration for a user platform 140 is further described below in relation to FIGS. 2-5. The user platform 140 may gain access to one or more content items from a content source 130, e.g., a third party content source such as Amazon, Netflix, Napster, CBS, etc., via services of a service provider 110 including, for example, Macrovision Corporation, Rovi Corporation, or another host or service provider. The user platform 140 may comprise, for example, a television (TV) 142, a digital video recorder (DVR) 143, or other user devices shown under user platforms 140. The user platforms 140 may also include a computer (PC) 144 and/or a network attached storage device (NAS) 146, such as a network router or a wireless access point device that may optionally form a home network. The user platforms 140 may also include a set-top box. The user platforms 140, for example, the television 142, the computer 144, and/or the set-top box may be coupled to the content source 130 via a content network 150. The content network 150 optionally includes a variety and/or a combination of video and/or television content distribution and/or delivery networks such as, for example, cable, satellite, terrestrial, analog, digital, standard definition, high definition, RF (UHF, VHF) and/or broadcast networks. The user platforms 140 and content sources 130 may have access to the wide-area data network 120, e.g., the Internet, as well.

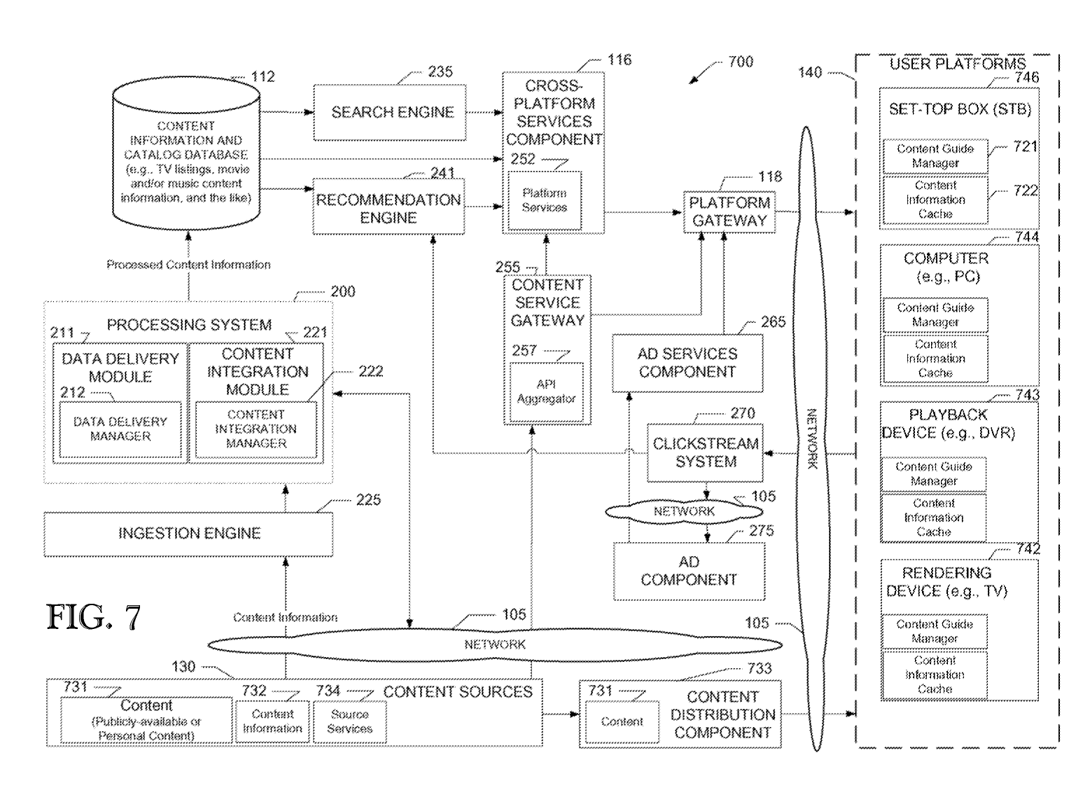

FIG. 1 also illustrates that an equivalent configuration of architecture 100, 101, and/or 700 of various embodiments can include multiple content information processing sites 108, each managing a portion of the functionality provided as described herein. A particular embodiment may include an additional layer, called the Partner Sites, wherein each Partner Site is hosted on a separate server and each Partner Site communicates with the user platform 140 and/or the content guide manager 721 (shown in FIG. 7) of a network-enabled user platform 140, described in more detail herein. In this embodiment, each Partner Site can manage a subset of the available content and content information from content sources 130. Further, it will be apparent to those of ordinary skill in the art that another equivalent configuration includes a portion of the functionality provided by the user platform 140 being downloaded from the service provider 110 and/or processing sites 108, such as a collocation facility, to the user platform 140 and executed locally at the client and/or user location. In any of these alternative configurations, the architecture 100, 101, and/or 700 of various embodiments provides and supports enabling content information aggregation and access by user platforms as described in more detail herein, in addition to the functions and/or services for content browsing and recommendation.

In an example embodiment shown in FIG. 2, the service provider 110 may comprise a service provider database 112, such as a content information database coupled via an intranet 114 to hosted services 115. The hosted services 115 may comprise a cross platform services (CPS) component 116 and a cross platform gateway (CPGW) or “platform gateway” 118. The platform gateway 118 may act as an interface between the user platform 140 and the service provider 110. The cross platform services component 116 may be responsible for processing requests from the user platform 140 via interactions with the content sources 130, as described in more detail below.

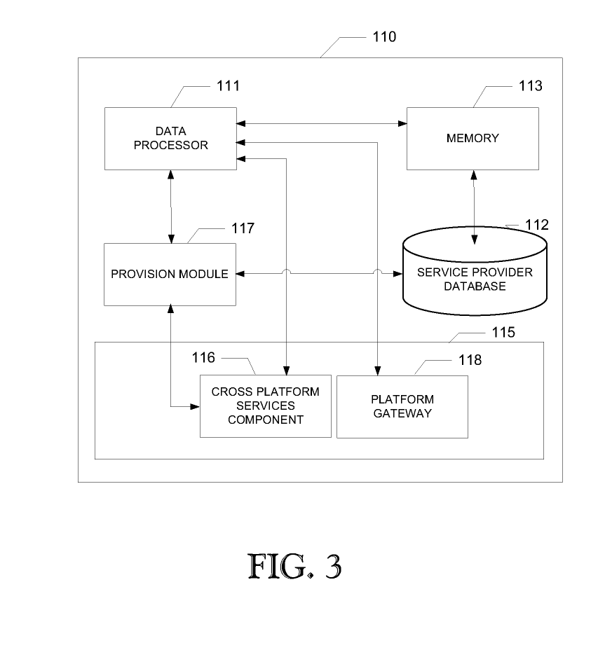

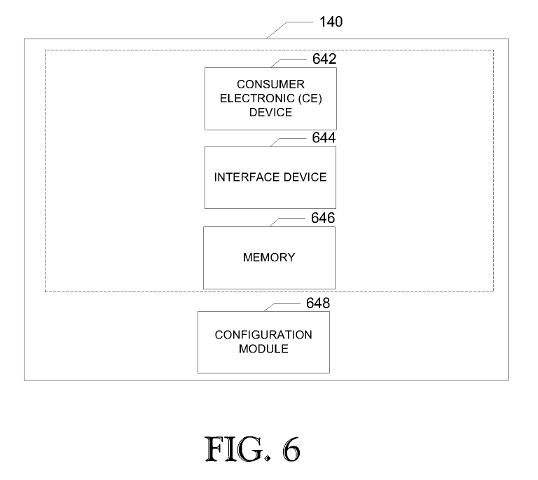

FIG. 3 is a diagram illustrating a more detailed example of a service provider 110 for delivering content to a user of a user platform that is preferably registered such as, for example, the user platform 140 of FIGS. 1 and 2. User platform 140 registration and/or device registration is further described below in relation to FIG. 6. As shown in FIG. 3, the service provider 110 comprises a data processor 111, a memory 113, a service provider database 112, a provision module 117, cross platform services component 116, and platform gateway 118. The provision module 117 may receive assets from various content sources such as, for example, the content sources 130 of FIGS. 1 and 2. The delivery of assets from the content source 130 may be via a wide-area data network 120 of FIGS. 1 and 2, such as the Internet. The assets may be received periodically, e.g., daily, in a batch mode operation or the provision module 117 may request assets from the content sources on demand or receive the assets in real time. In some embodiments, real time means as soon as the assets are available for delivery from the content source.

The assets may be temporarily stored in the memory 113 such as within a buffer, for example, from where the assets may be transferred and recorded in the service provider database 112, which may correspond, for example, to the service provider database 112 of FIG. 2. In operation, the data processor 111 may cause an interface device, such as, for example, the interface device 644 shown in FIG. 6 and described below, to present to a user of the user platform 140, information related to a number of content items retrieved from the assets. In an example embodiment, the data processor 111 may cause the provision module 117 to retrieve the content from the assets stored within the service provider database 112 and make the content accessible to the interface device 644 via the wide-area data network 120 of FIGS. 1 and 2, by using the platform gateway 118.

The platform gateway 118, which acts as an interface between the user platform 140 of FIGS. 1 and 2 and the service provider 110, may comprise software and/or hardware to translate between communication protocols used internally by the service provider 110 such as, for example, between the platform gateway 118 and the cross platform services component 116. These translated protocols may include, without limitation, a simple object access protocol (SOAP) and protocols used by the user platform 140 such as, for example, Internet Protocol (IP) and/or Transmission Control Protocol (TCP). The platform gateway 118 may receive, via the wide-area data network 120, from the user platform 140, a request by the user for content associated with the content source 130 of FIGS. 1 and 2.

The user may provide membership information regarding a membership with the content source 130 to the service provider 110, the first time the user attempts to access content from the content source 130, via the user platform 140. The membership information, for example, may include, but is not limited to, authentication information such as a username, a password and account identification, such as an account number and so forth. The membership information may be stored in the memory 113 in a member list associated with the content source 130 along with a registration code associated with the user platform 140 for future reference.

In later access attempts, the data processor 111 of the service provider 110 may determine that the user, and/or the user platform 140, has a membership with the content source 130, by referring to the member list associated with the content source 130 and the registration code of the user platform 140. Then, the data processor 111 may perform the authentication on behalf of the user, by using the stored authentication information, such that the user may access content from the content source 130 without explicit authentication being performed by the user.

Regardless of the foregoing alternatives, accessing the content from the content source 130 can be achieved via several methods. For example, the data processor 111 may cause the provision module 117 to allow the user to receive delivery of the content directly from the content source 130 to the user platform 140. This embodiment is beneficial because the service provider 110 does not have to provision the resources necessary to store selected content for a plurality of users. In another embodiment, the data processor 111 causes the provision module 117 to retrieve the content from the assets stored in the service provider database 112, and allow the user to receive delivery of the content from the service provider 110. In this embodiment, the service provider 110 first retrieves the content from the content source 130 and stores the content as assets in the service provider database 112. This embodiment is beneficial because the service provider 110 can retain control over the content delivery process.

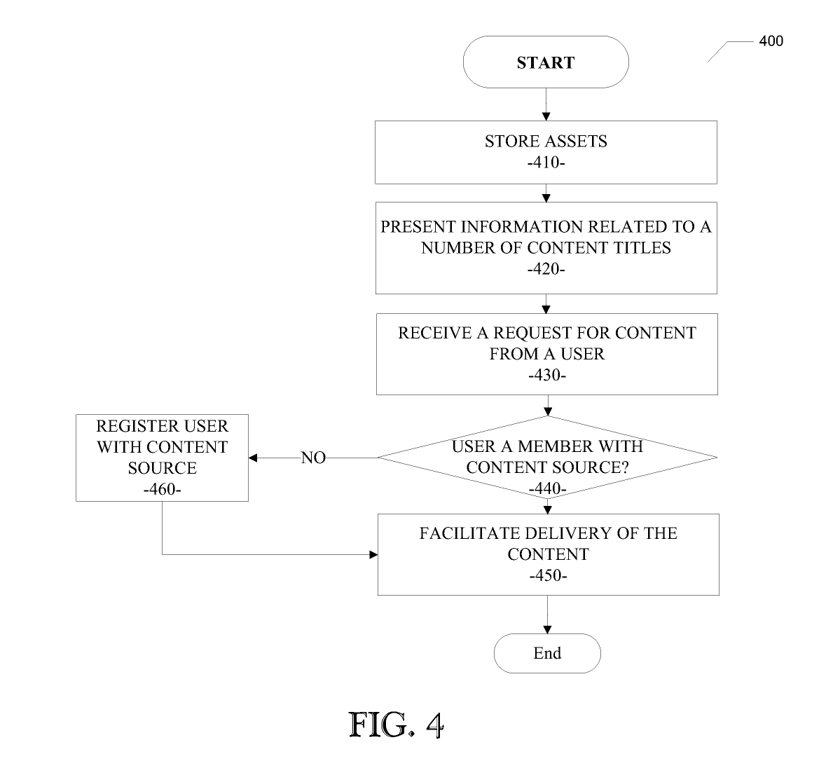

FIG. 4 is a flow diagram illustrating a further example method 400 of delivering content to a user of a user platform 140 of FIGS. 1 and 2, according to various embodiments. At an operation 410 shown in FIG. 4, assets or asset information received from the content source 130 may be stored in the service provider database 112 or memory 113. Information related to a number of content items retrieved from the assets can be presented, via the wide-area data network 120 of FIGS. 1 and 2, to a user of the user platform 140, at operation 420. The user determines if one or more of the content titles, presented as part of the content information, may be of interest. The user then submits a request for particular content titles to the service provider 110. The service provider 110, at operation 430, may receive a request from the user for one or more content items associated with the content source 130 from the user platform 140.

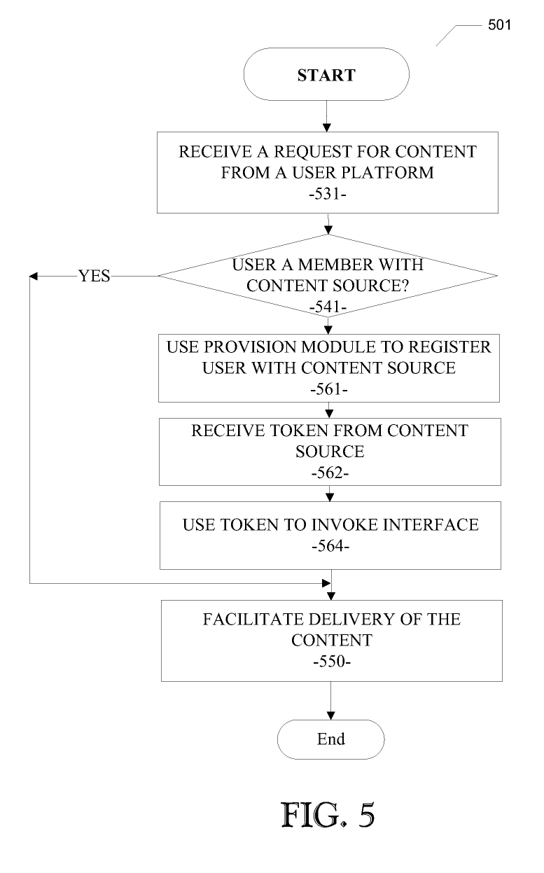

If it is determined at the control operation 440 that the user does not have a membership with the content source 130, and thus is not a registered user, then at operation 460, the data processor 111 causes the provision module 117 to automatically register the user with the content source 130. The registration of the user may proceed according to the steps described below in relation to FIG. 5.

If it is determined at the control operation 440 that the user does have a membership with the content source 130, and thus is a registered user, then at operation 450, the data processor 111 causes the provision module 117 to facilitate delivery of the requested content to the user without a need for explicit user authentication by the user. In order to skip explicit user authentication, upon receiving the request for content, the provision module 117 may receive an authentication token associated with the user from the content source 130 and invoke, by using the authentication token, an interface associated with the content source 130.

The provision module 117 may facilitate delivery of the requested content at operation 450 by allowing the user to download the content directly from the content source 130 on demand to the user platform 140. The provision module 117 may also retrieve the content from the assets stored in the service provider database 112 and allow the user to download the content from the service provider 110. Once registered with the content source 130, the user may download, stream, and/or receive content directly from the content source 130 to the user platform 140 without the need for explicit user authentication.

FIG. 5 is a flow diagram illustrating a further example method 501 of delivering content to a user of a user platform 140 of FIGS. 1 and 2, according to various embodiments. Preferably, the user platform 140 is registered. As shown in FIG. 5, a service provider 110 receives the request for the content from a user platform 140, at operation 531. If the data processor 111 determines, at operation 541, that the user does not have a membership with the content source, and thus is not a registered user, the data processor 111 may cause the provision module 117 to automatically register the user with the content source 130, at operation 561. For instance, the data processor 111 may cause the provision module 117 to receive an authentication token associated with the user from the content source 130, at operation 562, and invoke an interface associated with the content source by using the authentication token, at operation 564, to register the user with the content source 130 and allow the user to access the content, at operation 550.

More specifically, at operation 550, in response to receiving the request for content from the user platform 140, the data processor 111 may cause the provision module 117 to facilitate delivery of the content to the user, without a need for user authentication such as, for example, without the need for the user to login, provide a password, and/or provide payment or credit information, as described above. In some implementations, the provision module 117 is a software module, and the data processor 111 causes the software module to execute. With regard to registration of the user platform 140, the first time that a non-registered user platform 140 device is used, e.g., a consumer electronic (CE) device, television 142, or a digital video recorder (DVR) 143, the user may send a registration request. In another embodiment, the provision module 117 may automatically register the non-registered user platform 140 when the user platform 140 is coupled with the service provider 110 via a wide-area data network 120 for the first time. In one embodiment, for example, the provision module 117 provides the user with a registration code for the user platform 140. The user provides the registration code when the user explicitly registers the user platform 140 or refers to the user platform 140 in communications with the service provider 110. The user platform 140 of some embodiments is further described below with respect to FIG. 6.

### User Platform Registration

As mentioned above, the user platform 140 is preferably registered. The user platform registration or “device registration” operates alternatively, or in conjunction with, the “user registration” of some embodiments. User registration is used to identify and/or authorize a particular individual person for access to content via a user platform. User platform registration is used to identify and/or authorize a particular device or interface for access to content. Either or both types of registration can be used in various embodiments. FIG. 6 illustrates an example user platform 140, which may correspond to the user platform 140 shown in FIGS. 1 and 2. The user platform 140 preferably comprises a first consumer electronic (CE) device 642, such as the television 142 or the digital video recorder (DVR) 143 of FIG. 2, an interface device 644, a memory 646 and a configuration module 648. The memory 646 and/or the interface device 644 may be preconfigured within the television 142 and/or the digital video recorder 143. Alternatively, the memory 646 and/or the interface device 644 are added along with the configuration module 648 to form a non-registered user platform 140 that is enabled for registration. For instance, the memory 646 and/or the interface device 644 may optionally be coupled internally or externally to the television 142 and/or the digital video recorder 143.

As mentioned above, some user platforms 140 are initially not registered and require registration for operation with the service provider 110. In these cases, the first time that a user activates a non-registered user platform 140, the interface device 644 preferably communicates, via the wide-area data network 120, with the service provider 110. Once the non-registered user platform 140 communicates with the service provider 110, the configuration module 648 may work with the provision module 117 to register the non-registered user platform 140 with the service provider 110. When the registration is complete, the configuration module 648 may receive a registration code from the provision module 117. The configuration module 648 may then save the registration code in the memory 646 on the user platform 140. Once registered, the user platform 140 is ready to perform the functionalities described herein with respect to a registered user platform.

The interface device 644 may include hardware and/or software and may also provide various user interfaces to display a variety of information to the user. In an embodiment, the interface device 644 may receive the user interfaces from the service provider 110. The user interfaces, for example, may be used to display information related to a collection of content and associated metadata available from the service provider 110. The user interfaces may also provide for the user one or more search boxes to enable the user to search for content under a variety of lists such as title, artist, category, subject, company name, etc. The interface device 644, as mentioned above, may also provide connectivity between the user platform 140 and the service provider 110, via the wide-area data network 120. Interactions between the user platform 140 and the components of the architectures shown in FIGS. 1 and 2 are discussed in more detail below.

The content browsing and/or recommendation functions of various embodiments described herein are used to facilitate the correlation of content and related content information for delivery across various delivery media. FIG. 7 illustrates an example environment for a networked browsing and/or recommendation architecture 700 with which various embodiments operate. The networked browsing and/or recommendation architecture 700 includes the functionality of the service provider 110 described above plus additional features described below. As shown in FIG. 7, a processing system 200 is in networked communication, via a network 105, with one or more content sources 130, such as the content sources 130 shown in FIGS. 1 and 2. As shown in FIGS. 1 and 2, network 105 can be a wide-area data network 120, such as the Internet. Network 105 can also be a content network 150. Network 105 can also be a combination of either or both of the wide-area data network 120 and the content network 150. The processing system 200 is also in networked data communication, via the network 105, with one or more user platforms 140, such as the user platforms 140 shown in FIGS. 1 and 2. The one or more user platforms 140 may include or be in networked data communication with rendering devices 742, playback devices 743, computer 744, set-top box 746, and/or other types of user devices operating in or with user platform 140. For example, the television 142 shown in FIG. 2 may correspond to rendering device 742 shown in FIG. 7. The digital video recorder 143 shown in FIG. 2 may correspond to playback device 743 shown in FIG. 7. The personal computer 144 shown in FIG. 2 may correspond to computer 744 shown in FIG. 7. The network access system 146 shown in FIG. 2 may correspond to set-top box (STB) 746 shown in FIG. 7. The processing system 200 is preferably used to process content information 732 that is related to, but may be peripheral, ancillary, or distinct from, content 731 that is desired and requested by users for playback and/or rendering. As shown in FIG. 7, the environment for the architecture 700 preferably includes content information 732, content 731 in the form of items of content, and/or both.

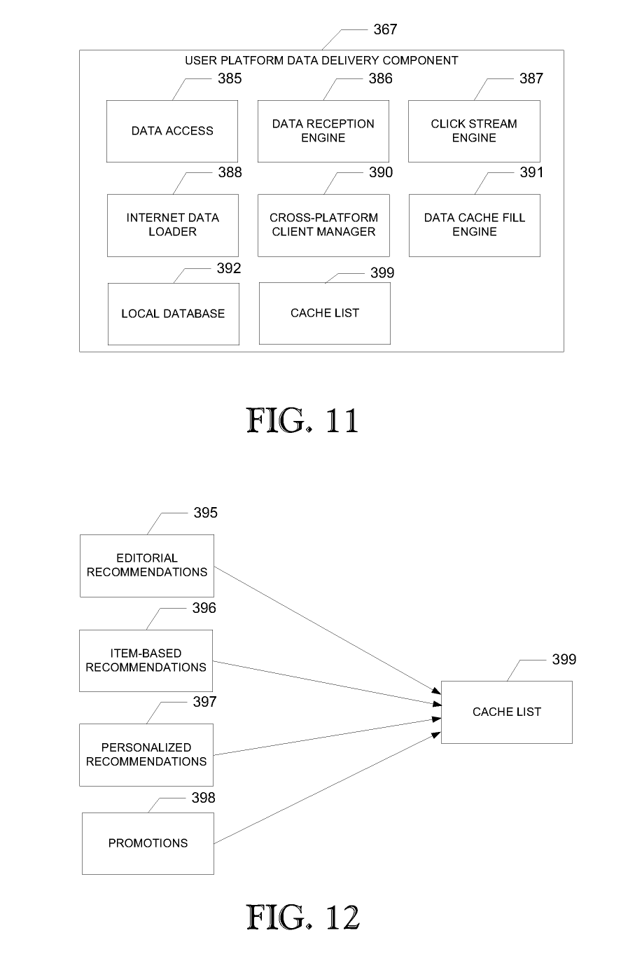

In some embodiments, the user platforms 140 are configured to communicate directly with the processing system 200 via the network 105. Further, the user platforms 140, such as the rendering device 742, the playback device 743, and/or the set-top box (STB) 746, may use local interfaces such as USB or local wireless interfaces such as Bluetooth, 802.11, 802.3, and the like, for direct data communication with the computer 744, which can communicate with the processing system 200. The user platforms 140 are used by individuals who can log in to or otherwise gain access to the processing system 200 via the network 105 and become subscribers or members of a content browsing and recommendation service enabled by the various embodiments described herein. The process for registration and/or activation by subscribers and non-subscribers is described in more detail above. In a particular embodiment shown in FIG. 7, some content guide and/or content information functions are selectively provided in or by one or more of the user platforms 140. For instance, in some embodiments, a particular user platform 140 is configured for or enabled with a content guide manager 721 and/or a content information cache 722. The content guide manager 721 controls the flow of a selected item of content into and out of a data buffer or local database 392 (shown in FIG. 11) for the user platform 140 for playback, rendering, and/or recording of content for a user. Additionally, the content guide manager 721 controls the flow of content information such as, for example, content metadata related to a selected item of content, into and out of the content information cache 722 of the user platform 140 as shown in FIG. 7.

The content guide manager 721 includes processing logic to communicate with the cross-platform services component 116 via platform gateway 118 and the network 105 to coordinate access to a user-selected item of content 731 directly from the one or more content sources 130 by the user platform 140 via the network 105. The cross platform services component 116 shown in FIG. 2 may correspond to cross platform services component 116 shown in FIG. 7. The platform gateway 118 shown in FIG. 2 may correspond to platform gateway 118 shown in FIG. 7. The content guide manager 721 also includes processing logic to communicate with the cross-platform services component 116 via the platform gateway 118 and network 105 to obtain available content information 732, and related content metadata, associated with identified items of content 731 available through the content sources 130. In an example embodiment, this content information 732 includes content information related to a particular content item. Content items are further described above in relation to FIGS. 1-2. The content information 732 may include content metadata, biographical information on the authors, writers, actors, directors, producers, or the like, background information on the content item, web links or text identifiers related to the content item, information identifying related content items, information related to categories, genres, or the like that relate to the content item, information identifying other users and/or viewers who may share an interest in content similar to the particular item of content, content reviews, and other content information related to the particular item of content. Content reviews can be summaries, critiques, overviews, polling or survey information, or other type of analysis, opinion, or parody of a particular content item. This content information, obtained by the processing system 200 from various content sources 130, is maintained in a database 112 by the processing system 200 of various embodiments. This content information can be made available to user platforms 140, via platform services 252, for viewing, searching, and/or selection by users of user platforms 140. The users of user platforms 140 can log in to accounts maintained by the processing system 200, search for lists of available content and related content information by using a search engine 235, and select a particular item or items of content and/or a related item or items of content information for download or streaming to the user platform 140 via local interfaces and/or network 105. Content distribution component 733 includes processing logic to communicate with one or more content sources 130 and one or more user platforms 140 to facilitate the downloading or streaming of a particular selected item of content to a user platform 140 of a requesting user. The content sources 130 can include feeds or repositories of digital content 731 that are downloaded or streamed to a particular user platform 140 via the network 105. The content 731 can include various forms of digital content including video or multimedia, e.g., MPEG, still images, e.g., JPEG or TIFF, audio, e.g., MP3, spoken audio, digital documents, executable code, and the like. The content sources 130 may represent websites, servers, peer-to-peer nodes, databases, data storage local to the processing system 200, data storage local to the user platforms 140, and the like. As described in more detail herein, the processing system 200 and the content sources 130 operate in concert with the content guide manager 721 to control the access to content information and content, and the playback of selected content on the user platforms 140 from the content sources 130. Note that in a particular embodiment, the selected item of content 731 can be downloaded or streamed directly from the content source 130 to the user platform 140 of a requesting user via the content distribution component 733 and network 105. In contrast, the content information 732 corresponding to a selected item of content 733 can take a different path to the user platform 140 of a requesting user. The content information can be obtained from content sources 130 and processed by ingestion engine 225. The content information can then be uploaded to database 112 by the data delivery module 211 of processing system 200. At a time of its choosing, a user platform 140, and the content guide manager 721 therein, can obtain the content information from the database 112 by using a platform service 252 of cross-platform services component 116. The content information can be downloaded to a requesting user platform 140 via the platform gateway 118 and stored in the content information cache 722 of the user platform 140.

Referring still to FIG. 7, the processing system 200 is in data communication with a plurality of content sources 130 via the network 105. The content sources 130 represent any of a variety of content producers, content aggregators, or other content sources from which a plurality of items of content 731 and related content information 732 can be obtained. Examples of content sources 130 include CinemaNow, Netflix, Amazon, CBS, Video Detective, and the like. The processing system 200 obtains content information 732, as related to various content items 731, from the content sources 130 via an ingestion engine 225. The ingestion engine 225 is configured to accept content information 732 in a variety of forms and formats. This variety of content information 732 is preferably normalized or otherwise re-formatted and structured into a form that is conveniently processed by the processing system 200. A data delivery manager 212 of the data delivery module 211 of the processing system 200 receives the ingested content information from ingestion engine 225 and determines a catalog or catalogs to which a particular item of content information relates. Additionally, the data delivery manager 212 performs classification, grouping, and cross-correlation operations to associate particular items of content information with content catalogs, content groupings, content types, content sources, or particular content items. The data delivery manager 212 performs the classification, grouping, and cross-correlation operations by using the data in the content information item itself. For example, keywords, metadata, tags, and the like can be extracted from the content information and used to categorize or classify a particular content information item in association with one or more content catalogs or groupings. Once the data delivery manager 212 processes the content information, the processed and classified content information is stored in a database 112 with information identifying associated content catalogs, categories, types, groupings, or content sources.

A content integration module 221 and content integration manager 222 of the processing system 200 is responsible for managing the delivery of content items 731, but not content information 732, to particular user platforms 140, with which users have made content selections. The content integration manager 222 coordinates the delivery of selected content items 731 from the content sources 130 to particular user platforms 140 via content distribution component 733 and the network 105. The delivery of selected content items 731 is processed as a content download or a streamed content feed, in some implementations.

The content information 732 stored in the database 112 by the data delivery manager 212 is structured and conveniently searchable by using search engine 235. The database 112 thereby retains all structured content information 732 across all content sources 130. The platform services 252 provided by the cross-platform services component 116 includes services for querying content information in the database 112 by using the search engine 235. The cross-platform services component 116 makes these platform services 252 available to user platforms 140 via the network 105 and the platform gateway 118. The platform services 252 can include services to enable a user platform 140 to search the processed content information in the database 112 based on a content catalog identifier, a content category, type, grouping, or content source. Other queries based on keywords, tags, or metadata are also supported by the platform services 252. The platform services 252 provided by the cross-platform services component 116 also include services for requesting a recommendation for content information by using a recommendation engine 241. The processing performed by the recommendation engine 241 is described in more detail below.

The recommendation engine 241 obtains user behavior information, and optionally user profile information (collectively denoted user interest information), to correlate user interests with corresponding content information retained in the database 112. For this purpose, the recommendation engine 241 is coupled to a clickstream system 270 as shown in FIG. 7. The clickstream system 270 is in data communication with a plurality of user platforms 140 via the network 105. The clickstream system 270 collects user behavior information including mouse click events, mouseover events, webpage access and/or view events, object selection events, purchase or bid events, and the like. Additionally, a user identifier and optionally a user profile can also be associated with the user behavior information to form the user interest information. This user interest information is provided to the recommendation engine 241 by the clickstream system 270 and is used by the recommendation engine 241 to correlate user interests with corresponding content information retained in the database 112. Additionally, the clickstream system 270 may provide the user interest information to an advertisement (ad) component 275 via the network 105. The ad component 275 is used for making decisions regarding which ads to serve to a user, and for reporting ad relevant information, such as click through and/or conversion rates and the like. The ad component 275 may use the user interest information to target advertisements that relate to the users operating a particular user platform 140. The ad component 275 may further determine which ads to deliver to a particular user platform 140. The ad component 275 may notify the ad services component 265 with information identifying particular advertisements that should be delivered to identified user platforms 140. The ad services component 265 delivers the selected ads to the identified user platforms 140. The ad component 275 may also generate reports detailing how the advertisements were targeted.

Referring still to FIG. 7, a content service gateway 255 is shown in data communication between the cross-platform services component 116 and the content sources 130. The content service gateway 255 is responsible for communication with content sources 130 such as from third party sources. The content service gateway 255 aggregates application programming interfaces (API's) by using an API aggregator 257. The API aggregator 257 generates a generalized abstracted content service API from the various individual API's provided by each of the content sources 130. In essence, the API aggregator 257 builds a generalized abstracted content service API on top of the different API's provided by each of the content sources 130. In this manner, the API aggregator 257 generates a standardized content service API that can be used by cross-platform services component 116 and user platforms 140 via the platform gateway 118. The user platforms 140 of an embodiment preferably use the standardized content service API of the content service gateway 255 for real-time communication with any of a variety of content sources 130.

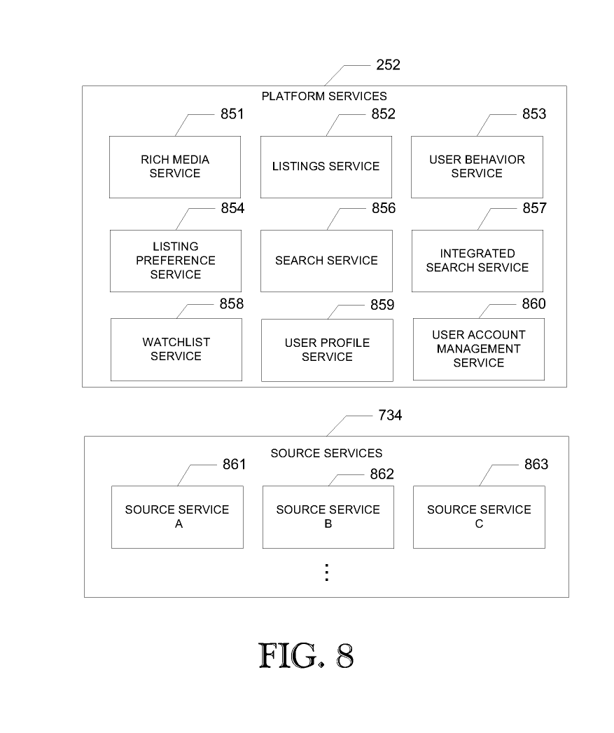

The cross-platform services component 116 provides a uniform service interface for the user platforms 140. In one embodiment, this service interface provided by the cross-platform services component 116 is a web service interface. In an example embodiment, the platform services 252 supported by the cross-platform services component 116 include, for example, one or more of the following services: user account management services, user platform profile management services, recommendation services, search services, listings services, listing preferences services, remote record services, rich media services, watchlist services, user behavior services, and/or user profile services. A set of platform services 252 offered in an example cross-platform services component 116 is further described in relation to FIG. 8.

FIG. 8 illustrates a set of example platform services 252 and source services 734 supported by some embodiments such as, for example, the cross-platform services component 116 of FIG. 7 and content sources 130. As shown in FIG. 8, the platform services 252 include a rich media service 851, a listings service 852, a user behavior service 853, a listing preference service 854, a search service 856, an integrated search service 857, a watchlist service 858, a user profile service 859, and a user account management service 860. In each case, the platform services 252 provide a uniform service interface for the user platforms 140 described herein.

The rich media service 851 enables a user of a user platform 140 to configure the user platform for the presentation of rich media content, such as images, graphics, or video. The listings service 852 enables a user of a user platform 140 to view content item listings as stored in a database 112. The user behavior service 853 enables a user of a user platform 140 to configure the user platform to capture and report user behavior data in a desired manner. The listing preference service 854 enables a user of a user platform 140 to specify types of content listings likely of interest to the particular user. The search service 856 enables a user of a user platform 140 to search content item listings as stored in the database 112. The integrated search service 857 enables a user of a user platform 140 to search content item listings as stored in the database 112 or accessible via the network 105. The watchlist service 858 enables a user of a user platform 140 to specify types of content items for which the user wishes to be notified when the specified content items become available. The user profile service 859 enables a user of a user platform 140 to manage the parameters retained in a user profile related to the user. The user account management service 860 enables a user of a user platform 140 to manage the parameters retained in a user account related to the user.

FIG. 8 also illustrates a set of source services 734. Source services 734 are provided by and sometimes resident in the content sources 130. Some content sources 130 provide various services 861, 862, and 863 of their own, which enable a consumer to browse, access, purchase, and download particular content items offered by the particular content source 130. However, other content sources 130 may not provide any source services or the provided services may not be compatible or efficient for use with the content information aggregation system described herein. As such, a particular embodiment can be configured to use the source services 734, if the source services 734 are provided by the content source 130. But, the various embodiments described herein do not rely on or require that such source services 734 be provided by the content source 130. One of ordinary skill in the art will recognize additional services can be provided alternatively and/or in conjunction with the service sets illustrated in the example of FIG. 8.

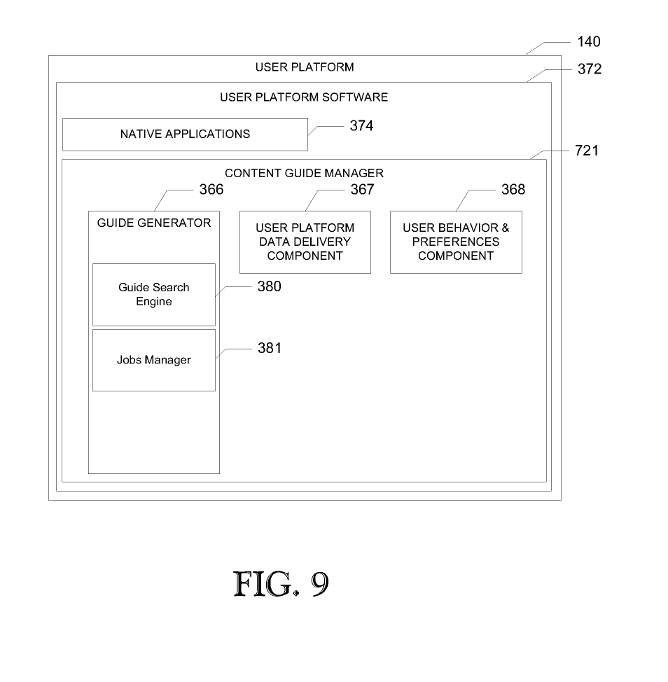

A user platform 140 according to an example embodiment is further described by reference to FIGS. 9 through 13. As shown in FIG. 9, the user platform 140 is configured to include user platform software 372. All or portions of the user platform software 372 can be installed within the user platform 140 firmware or downloaded into the user platform 140 via a network 105. The user platform software 372 includes native applications 374, which perform standard functions on conventional user platforms 140. Additionally, the user platform software 372 may be configured to include a content guide manager 721 that is preferably installed within the user platform software 372. The content guide manager 721 is configured to communicate with the various components of the architecture 700 of FIG. 7 to coordinate the selection and delivery of particular items of content and content information to a user platform 140. The content guide manager 721, in an example embodiment, includes a guide generator 366, a user platform data delivery component 367, and a user behavior & preferences component 368. The guide generator 366 gathers content information by using the architecture 700 and builds a user interface compliant electronic and/or interactive program guide (EPG and/or IPG) for display to a user of a user platform 140. The guide lists the various content items and content information as selected by a user. Native applications 374 can access the guide generator 366 to obtain data to populate program guides or to build content metadata browsing experiences for a user. The guide generator 366, in turn, uses the user platform data delivery component 367 to obtain the content information data from the architecture 700, as described above. The user behavior & preferences component 368 provides user-side functionality to gather user behavior data used by the clickstream system 270. The user behavior & preferences component 368 further stores user preferences with which the user can customize the interfaces and services provided on a particular user platform 140. The user behavior data includes mouse click events, mouseover events, webpage access and/or view events, object selection events, purchase or bid events, and the like.

As shown in FIG. 9, the guide generator 366 according to an example embodiment, is configured to include an electronic program guide (EPG) search engine 380 and a jobs manager 381. The guide search engine 380 provides application program interfaces to query the guide listings data, channel mapping, and the like, stored in the database 112 of the architecture 700. The jobs manager 381 schedules jobs to occur at particular times such as, for example, according to a periodic schedule of events. In this case, the jobs manager 381 schedules the content information cache filling operations described herein.

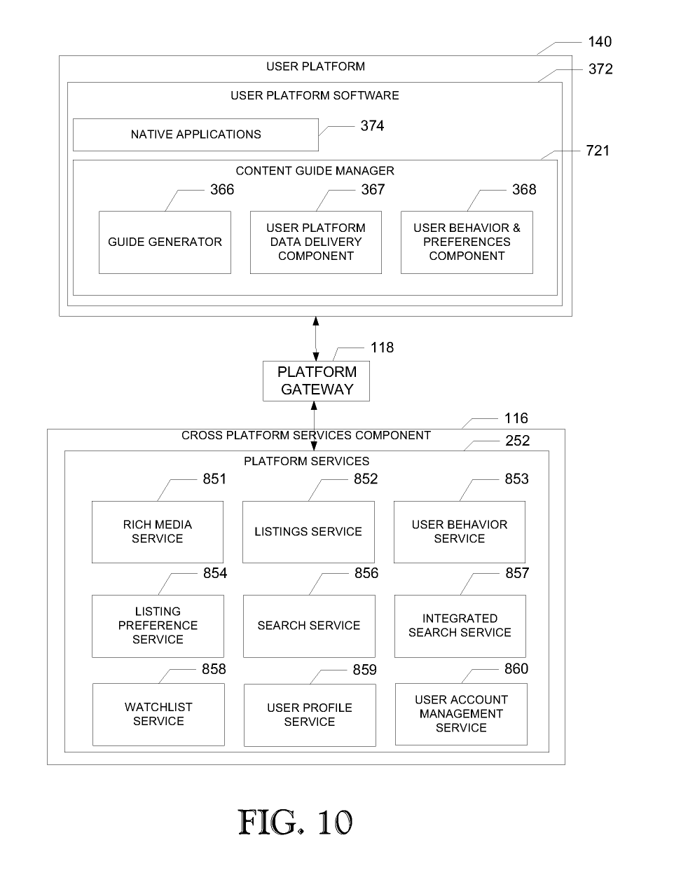

FIG. 10 illustrates an example environment showing an example data connection between the user platform 140 and the cross platform services component 116 with platform services 252 included therein. A platform gateway 118 can be used to facilitate networked data communications between the user platform 140 and the cross platform services component 116 via network 105. In this manner, the user platform 140, and a user thereof, may access and use the platform services 252.

FIG. 11 illustrates the user platform data delivery component 367 of an embodiment in further detail. As shown in FIG. 11, the user platform data delivery component 367 is configured to include a data access module 385, a data reception engine 386, a click stream engine 387, an internet data loader 388, a cross-platform client manager 390, a data cache fill engine 391, a local database 392, and a cache list 399. The data access module 385 provides access to the local database 392, in which local data such as, for example, guide data and/or content information, are preferably stored. The data reception engine 386 unpacks the content information delivered by the architecture 700 via the internet data loader 388 and populates the local database 392 by using the data access module 385. In a particular embodiment, the user platform 140 indicates to the architecture 700 which channel lineup the user platform 140 needs, and the user platform 140 receives only the content information, e.g., the listings data, for that lineup. The click stream engine 387 records the user's behavior and reports the user behavior back to the clickstream system 270 via the user behavior module 368. The cross-platform client manager 390 provides a user platform-resident interface for platform services 252 through the platform gateway 118. The data cache fill engine 391 uses the cross-platform client manager 390 to contact platform services 252 and retrieve content information such as, for example, metadata to be cached in the local database 392 for local use on the user platform 140. In a particular embodiment, the local database 392 can be used as content information cache 722 maintained on each user platform 140.

In a particular embodiment, the user platforms 140 maintain a local cache 722 of content information, e.g., metadata, which is available immediately to the user. This content information cache 722 is built by retrieving or generating a list of content information items to fetch by using the platform services 252 on a periodic, e.g., daily, basis. The cache filling may be controlled by a server as a method of load balancing, so that the platform services 252 are used as evenly as possible over time. On a periodic basis such as, for example, once per day, the user platform 140 queries the platform services 252 to retrieve content information identifiers with which the user platform 140 can generate a cache list 399 for the user platform 140. The user platform 140 can also determine the time the user platform 140 should begin filling its content information cache 722. At the correct time, as determined and/or scheduled by the jobs manager 381, the user platform 140 communicates with the platform services 252 and retrieves content information items that are identified in the cache list 399.

Referring to FIG. 12, the factors used in an example embodiment to fill the content information cache 722 in a user platform 140 are illustrated. In the example of FIG. 12, these factors include editorial recommendations 395, item-based recommendations 396, personalized recommendations 397, and promotions 398. These factors are used to generate the content information cache list 399. In essence, the factors provide information indicative of the types of content information that is likely of interest to a particular user of a user platform 140. The more accurate the factors are for a particular user, the more likely it is that the content information ultimately requested by the user will already be resident locally in the content information cache 722 in the user platform 140. If the requested content information is already stored in the content information cache 722, the user platform 140 need not incur the time and expense to obtain the requested content information via the architecture 700. Given an accurate set of factors, the user platform 140 infrequently, or as infrequently as possible, may need to perform an access to the real-time platform services 252 of the architecture 700 in response to user action. Thus, the user platform 140 and the other portions of architecture 700 of various embodiments is able to predict the prospective user demand based on user behavior, prior user content selection, and user profiling. Nevertheless, any requested content information that is not in the content information cache 722 is fetched via the platform services 252 of the architecture 700.

### Content Integration of an Example Embodiment

One of the key features of the various embodiments described herein is the ability to guide the user to content that is available via traditional and non-traditional means. Some of these non-traditional means may include:
Video On Demand such as from Amazon
Other video delivery means such as Netflix Instant Queue
White-box services such as CinemaNow and/or other brand experiences such as Blockbuster
Ad-supported services, e.g., broadcast and cable networks
Premium music services such as Rhapsody
Mixed-model music services such as Pandora
User-generated content services, e.g., Flickr and YouTube

Once the various embodiments have guided the user to the available content as described herein, some embodiments enable the user to access selected content items via a public and/or private data network. In some cases, this process of providing access to selected content items involves user registration or linking with an existing user account as described above. In some cases, the process involves transactions where the user pays for access to the content. However, once the user has selected a particular content item and provided registration and/or payment information for the selected content, the various embodiments then provide the content to the user. This portion of the various embodiments described herein for providing the content to the user is denoted content integration, which is described in more detail below.

As described herein, various embodiments provide a service technology that allows for the ingestion and correlation of content and catalog information into one or more databases to indicate the availability and accessibility of Internet-based content and/or network accessible content. The ingested content and/or catalog information may be stored and/or presented in conjunction with and/or in a manner that is similar as for linear television data. Instead of indicating that a particular program is available on a certain channel of a lineup at a certain time, this content and catalog information may indicate that a particular program is available via an Internet-enabled content source. Additionally, these services can allow the linking of user platform devices and user profiles to accounts with these content sources.

Because the content sources 130 that provide the content 731 have a wide variety of goals for doing so, various embodiments accommodate different models for the content sources 130 to deliver content to the user platforms 140. In various embodiments, there are at least three models of content integration as described below:
A first model of content integration involves a custom application on the user platform 140 that generates a high-quality, tightly integrated experience around the content 731 from a particular content source 130. This first model involves components and processes with which the user platform 140 communicates directly with the services and API's of the particular content source 130 for access to the content itself and for access to content information, including content directories, metadata, tags, reviews, blogs, and the like provided by the particular content source 130. Alternatively, the user platform 140 utilizes the services of an architecture such as the architecture 100, 101, and/or 700 described above, for access to the content itself and for access to content information, including content directories, metadata, tags, reviews, blogs, and the like provided by the particular content source 130 via the architecture 100, 101, and/or 700. A hybridization of these approaches is also possible.
A second model of content integration involves using the services of an architecture 100, 101, and/or 700, with an application on the user platform 140 that offers a small amount of customization in the form of skinning and the presence or absence of advertising content while browsing the directory of content available from the content sources 130. Skinning refers to placing a “skin” or a custom user interface or webpage over an interface or page provided by a content source 130. This second model may not allow for the flexibility of the full-custom application of the first model, but may be used for a broad set of content sources 130.
A third model of content integration involves the content sources 130 developing specialized web sites for use with user platforms 140 and the platform services 252 described above in relation to FIGS. 7, 8 and 10. This third model may not provide an experience that is as graphically rich as a custom experience, but allows for flexibility and control of the experience by the content source 130.

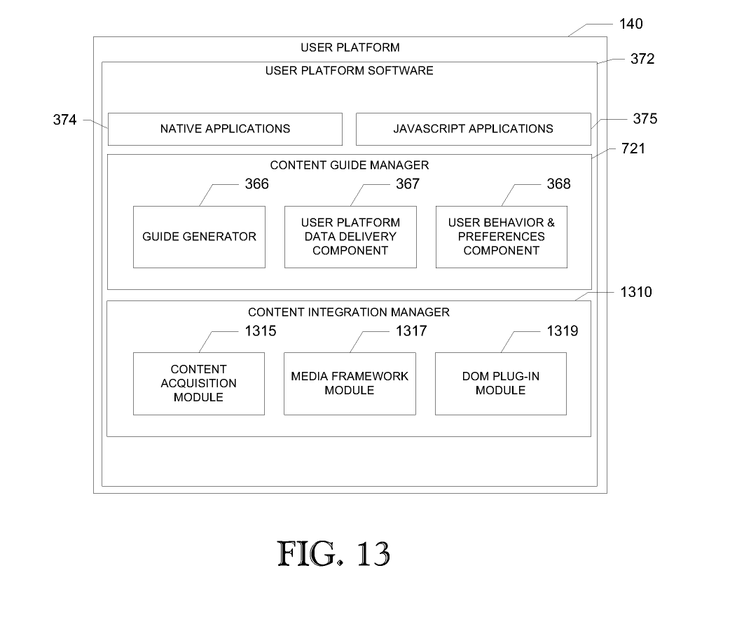

FIG. 13 further illustrates a user platform 140 according to an example embodiment, wherein the example user platform 140 includes components for content integration. As shown in FIG. 13, a user platform 140 is configured to include user platform software 372. All or portions of the user platform software 372 can be installed within the user platform 140 firmware or downloaded into the user platform 140 via a network 105. The user platform software 372 includes native applications 374, which perform content-related functions on the user platform 140. Native applications 374 on the user platform 140 are used to couple the user platform 140 to the platform services 252, or directly to source services 734 that are provided by the content sources 130, to search and browse content directories, gain access to content, and play selected content items. JavaScript applications 375 may be written by and/or for the content sources 130 and installed on the user platform 140 to enable a user of the user platform 140 to browse content directories of the content source 130, gain access to content, and play selected content items.

Additionally, the user platform software 372 may be configured to include content integration manager 1310 as installed in the user platform software 372. The content integration manager 1310 is configured to communicate with the various components of the architecture 100, 101, and/or 700 and/or content sources 130 directly to coordinate the delivery of selected items of content to a user platform 140. The content integration manager 1310, in an example embodiment, includes a content acquisition module 1315, a media framework module 1317, and a Document Object Model (DOM) plug-in module 1319. The content acquisition module 1315 of an example embodiment is configured to communicate with the content integration module 221 and content integration manager 222 of the processing system 200 of FIG. 7 to coordinate the delivery of selected items of content from a particular content source 130 to a user platform 140 via a content distribution component 733. As described above, the content integration module 221 and content integration manager 222 of the processing system 200 is responsible for managing the delivery of content items 731, but not content information 732, to particular user platforms 140, with which users have made content selections. The content integration manager 222 coordinates the delivery of selected content items 731 from content sources 130 to particular user platforms 140 via the content distribution component 733 and the network 105. The delivery of selected content items 731 is processed as a content download or a streamed content feed, in some implementations. The content acquisition module 1315 of an example embodiment is configured to communicate directly with the content sources 130 via network 105 to direct the transmission of selected content 731 to the requesting user platform 140. The content acquisition module 1315 can also be configured to communicate directly with the content sources 130 via network 105 for the acquisition of selected content 731. The media framework module 1317 of an example embodiment provides the structure and functionality definitions of the media playback and rendering capabilities of a particular user platform 140. The document object model module 1319 of an example embodiment provides access to the media framework 1317 so the content can be played or recorded.

Content integration via the processing system 200 enables the ability to adapt to protocol changes without updating the software on the user platform 140, thereby providing flexibility as business models and understanding of use cases evolve. As described in relation to FIG. 7, the architecture 700 enables a user platform 140 to obtain content information from a database 112. The content information provides a user with searchable information related to particular items of content available from various content sources 130. When using the architecture 700, if a user platform 140 requests availability information for a particular item of content 731, the search returns hits for the content sources 130 that provide the particular item of content 731, as well as results from the database 112. When using the architecture 700, a native application 374 on the user platform 140 may allow the user of the user platform 140 to acquire the selected content 731 via the content acquisition module 1315 and jump directly to playing the content 731 by using the media framework module 1317 and document object model module 1319. In a particular embodiment, there is no need to jump into another application associated with that particular content source 130.

In an alternative embodiment, the user platform 140 acquires the selected content 731 directly from the content sources 130 by using the source services 734. The primary drawback to this approach is that changes to the services and/or protocols used by the content sources 130 require an update of the user platform 140 such as, for example, a software update. The primary advantage of this alternative approach is simplified registration either for the user, the user platform 140, for the architecture 100, 101, and/or 700, and/or for the content sources 130.

In another alternative embodiment, the user platform 140 acquires the selected content 731 by using the architecture 700 or by using source services 734 provided by the content sources 130 directly. In this implementation, the user platform 140 may acquire related advertising by using the architecture 700 and the ad services component 265 therein, as described in relation to FIG. 7. Because the integration of content 731 and related advertising on a user platform 140 may require a higher level of control and/or device-specific information, the ad services component 265 in cooperation with the user platform software 372 may provide the necessary level of control to support ad services on the user platform 140.

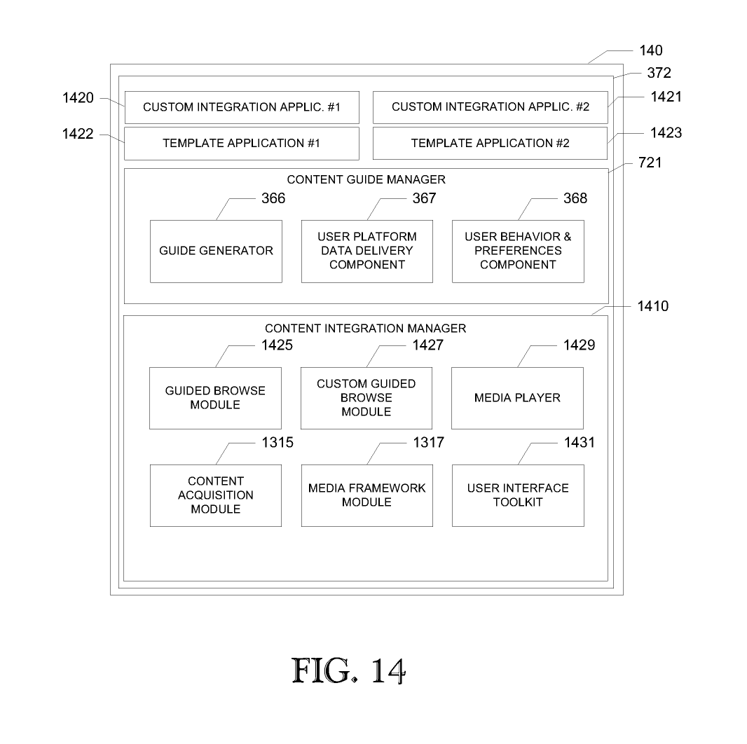

FIG. 14 illustrates an alternative implementation of a user platform according to another example embodiment, wherein the example user platform 140 includes components for content integration by using custom integration applications 1420 and/or 1421 on the user platform 140. When it is mutually advantageous to a host (e.g., a service provider 110) or a user platform 140 manufacturer and/or one or more content sources 130, custom integration applications 1420 and/or 1421 are generated for a user platform 140 to enable a user to browse and play content on the user platform 140. In this case, the user browsing experience is highly customized and well integrated into the overall user experience. Implementing the custom integration applications 1420 and/or 1421 natively allows for a sophisticated browsing experience and the use of advanced rendering and animation techniques. The custom integration applications 1420 and/or 1421 provide the presentation layer for browsing, acquiring rights to, and initiating playback of content from the content source 130. As shown in FIG. 14, a user platform 140 is configured to include user platform software 372. All or portions of the user platform software 372 can be installed within the user platform 140 firmware or downloaded into the user platform 140 via a network 105. The user platform software 372 may include custom integration applications 1420 and/or 1421, which perform customized content-related functions on the user platform 140. Custom integration applications 1420 and/or 1421 on the user platform 140 are used to couple the user platform 140 to platform services 252, or directly to the source services 734 provided by the content sources 130, to search and browse content directories, gain access to content, and play selected content items. The template applications 1422 and 1423 preferably include content integration applications that are not customized or specific to a particular content source 130. The guided browse module 1425 handles the data model for browsing and searching content by using a protocol compatible with the architecture 100, 101, and/or 700. The guided browse module 1425 of the content integration manager 1410 is used to retrieve content information by using a protocol compatible with the architecture 100, 101, and/or 700, and to provide this content information to the template applications 1422 and 1423 provided in the presentation layer of the user platform software 372. This content information may be used to retrieve the selected content 731, itself. The custom guided browse module 1427 preferably uses a specific protocol or service of a particular content source 130. The custom guided browse module 1427 is used to retrieve content information by using a specific protocol compatible with a particular content source 130 and to provide this content information 732 to the custom integration applications 1420 and 1421 provided in the presentation layer of the user platform software 372. This content information may be used to retrieve the content 731, itself in a customized application. The media player 1429 is provided to authenticate a user platform 140 with the content distributor 733 and to play the media with the selected content 731. The user interface (UI) toolkit 1431 is provided to support some basic user interface structures, functionality, and data objects from which a particular user interface is built and customized. The content sources 130 that either want full control of the user experience or that do not integrate with the architecture 100, 101, and/or 700 may provide web pages for access to their content catalogs and content, provided that the content sources 130 develop those web pages according to pre-established guidelines. These guidelines are based on the capabilities of the browser that is embedded into a user platform 140. In order to facilitate media playback of content provided by using this mechanism, the document object model module 1319 may be required to provide access to the media player on the user platform 140. The user interface toolkit 1431 also supports conventional user interface technologies, e.g., AJAX, CSS-TV, CE-HTML and may provide a wide array of layout options and advertising capability for the content sources 130.

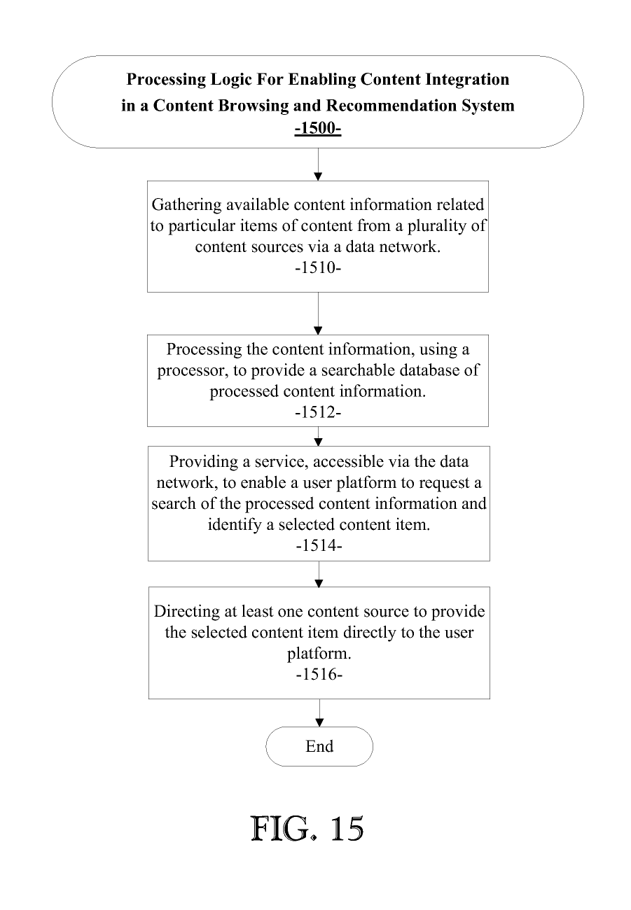

FIG. 15 illustrates a sequence of processing operations in an example embodiment. As shown in FIG. 15, the processing operations performed by an example embodiment 1500 include: gathering available content information related to particular items of content from a plurality of content sources via a data network, at processing block 1510; processing the content information, by using a data processor, to provide a searchable database of processed content information, at processing block 1512; providing a service, accessible via the data network, to enable a user platform to request a search of the processed content information and identify a selected content item, at processing block 1514; and, directing at least one content source to provide the selected content item directly to the user platform, at processing block 1516.

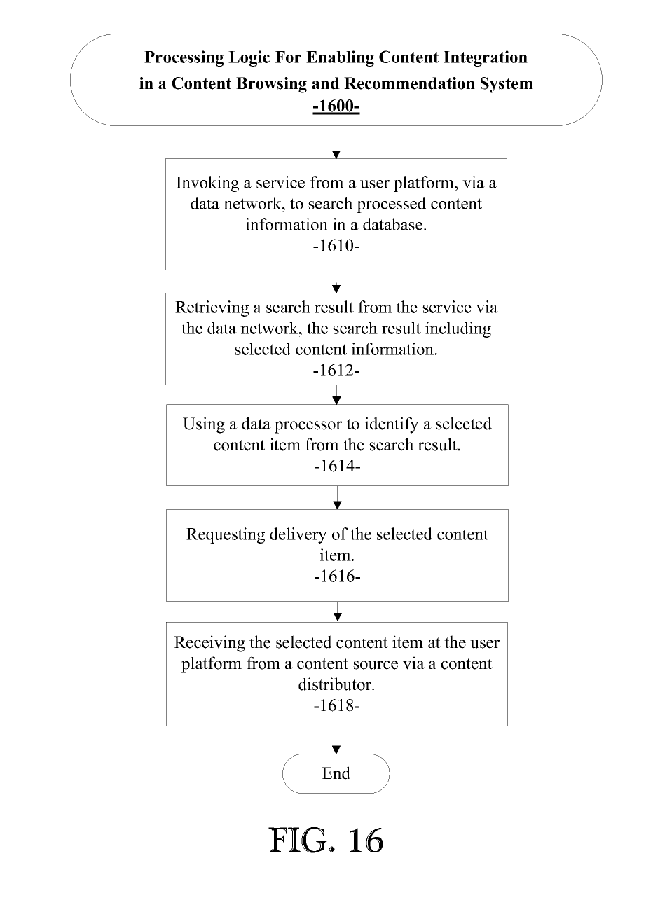

FIG. 16 illustrates a sequence of processing operations in an example embodiment. As shown in FIG. 16, the processing operations performed by an example embodiment 1600 at a user platform include: invoking a service from a user platform, via a data network, to search processed content information in a database, at processing block 1610; retrieving a search result from the service via the data network, the search result including selected content information, at processing block 1612; using a data processor to identify a selected content item from the search result, at processing block 1614; requesting delivery of the selected content item, at processing block 1616; and receiving the selected content item at the user platform from a content source via a content distributor, at processing block 1618.

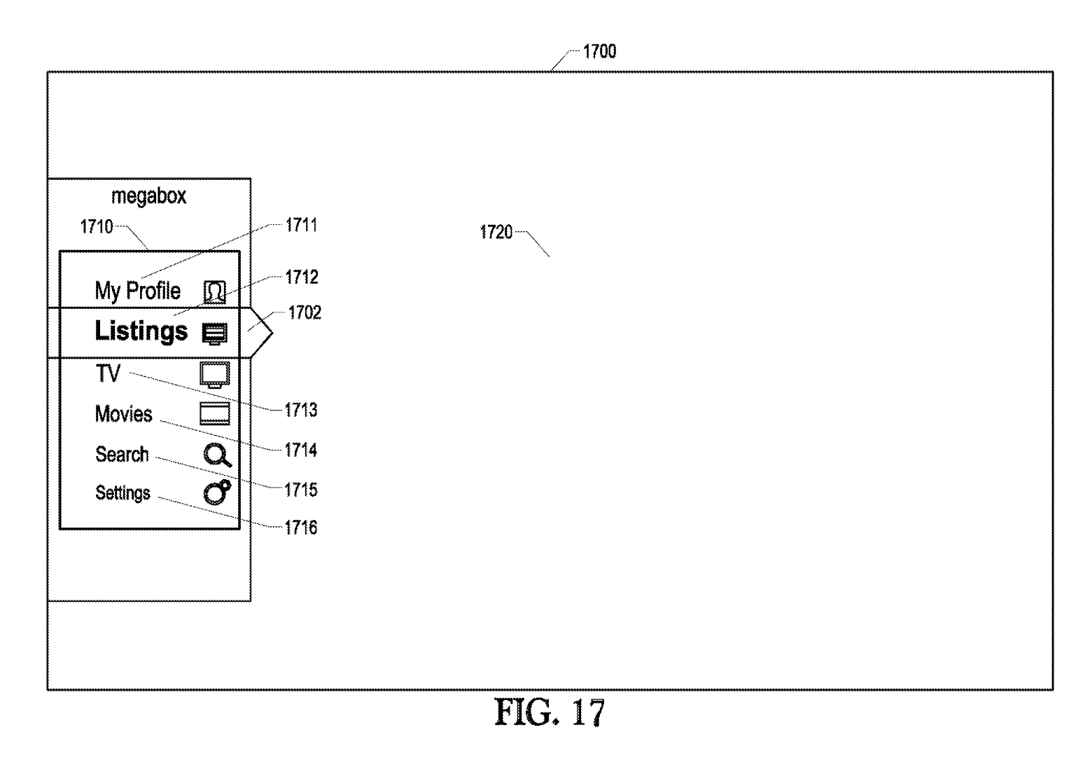

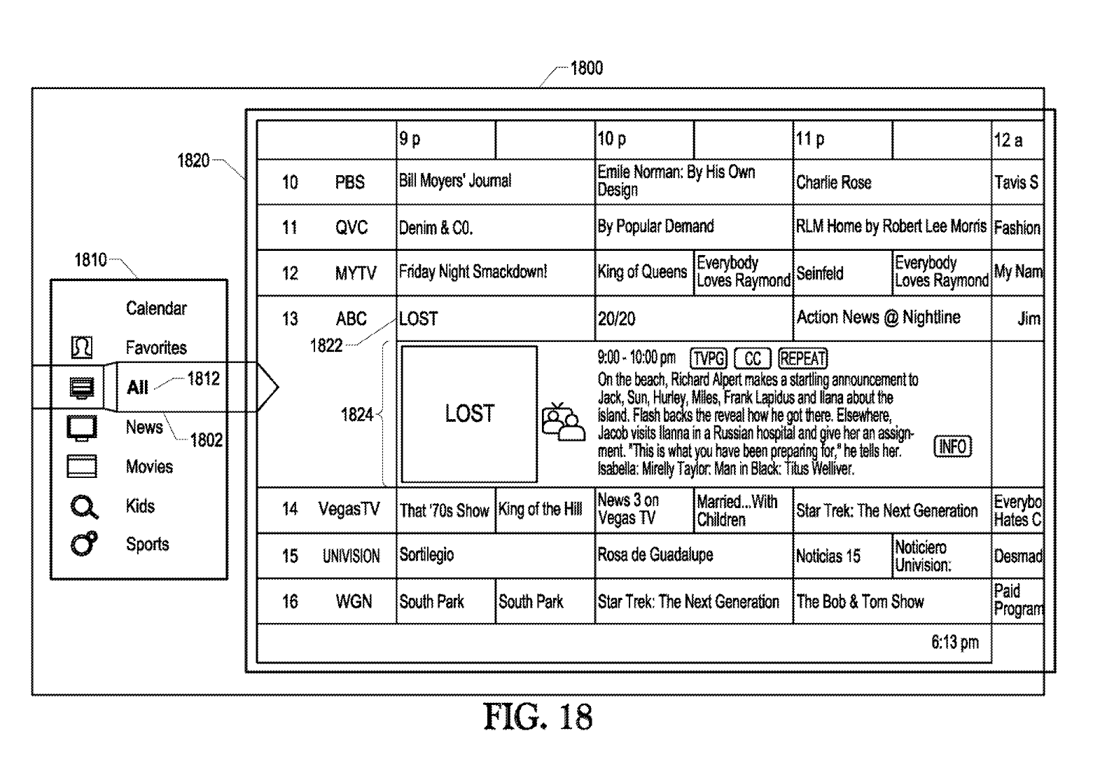

FIGS. 17 through 38 illustrate various example interface components of a sample content browsing and selection user interface provided in an example embodiment. In the sample user interface shown, a selection of content items can be shown with a display object, icon, or user-selectable component representing each content item. As described above, these content items can represent any of a variety of content including video, audio, still imagery, graphics, animation, video games, movies, music, spoken audio, digital books, documents, and the like. Each content item or content asset can be taken to include, but is not limited to, one or more collections of content, content information and metadata associated with the content, e.g., descriptions, synopses, biographies, trailers, reviews, links, related cast or crew, related content items, etc., and content source catalogs. Each content item or content asset can contain a representation of particular content, a link to corresponding content, and content information related to the content item. As described herein, the user interface examples shown in FIGS. 17 through 38 can be used to browse, search, and select content items and content information in a variety of dimensions of information related to a number of content items. The content items and related dimensions of content information may be presented to the user of the registered user platform as described herein.

Referring now to the example shown in FIG. 17, the sample content browsing and selection user interface includes a Root page 1700 that provides a content area 1720 and a set of user-selectable command options 1711, 1712, 1713, 1714, 1715, and 1716 in a command option area 1710 of the Root page 1700. Note that the rectangular box shown surrounding the command option area 1710 is provided in the figures herein merely to highlight the area for explanation and is not needed in the actual interface of the example embodiments described herein. A user can manipulate a conventional television remote control device, cursor control device, keyboard arrow buttons, or other pointing and/or control mechanism to select one of the command options 1711, 1712, 1713, 1714, 1715, or 1716 in the command option area 1710. Additionally, the user can select a particular command option of the command options 1711, 1712, 1713, 1714, 1715, and 1716 by using a select button on a conventional television remote control device, conventional mouse, wireless telephone, or other user platform control device to select (e.g., click on) a desired command option. A user selection of a particular command option 1711, 1712, 1713, 1714, 1715, and 1716 can also be activated in response to a mouseover event or ‘hover’ operation in the proximity of the desired command option 1711, 1712, 1713, 1714, 1715, or 1716.

In the example Root page 1700 shown in FIG. 17, the user is given an option to select from among several different command options, content sources, or content source types. For example, a user can choose to select a movie to watch by using a ‘Movies’ command option 1714 to select from a source of movie content items via a Movie Portal described in more detail below. Alternatively, a user can choose to select a television program by using a ‘TV’ command option 1713 to select from a source of television content items via a TV Portal described in more detail below. Alternatively, a user can choose to select content from a ‘Listings’ command option 1712, which can provide an aggregated list of content items with associated content information in a Listings page, the content lists being obtained from a variety of sources, including television programming sources, movie sources, music sources, spoken audio sources, game sources, image sources, special feature sources, scheduled media sources, on-demand and/or pay-per-view media sources, broadcast sources, multicast or unicast sources, downloaded sources, streamed media sources, recorded media sources, digital book sources, text document sources, content in a personal library or a personal library of an associate, and/or media or content that is delivered by another means. In one embodiment, the Listings page can be represented as a grid arrangement of content item listings in rows and time slots in columns. In this manner, scheduled content can be shown in a Listings page in association with a time period when each content item is available for viewing, listening, or reading. Alternatively, the Listings page can be represented as a list of content items without an indication of time corresponding to availability of the content. In this embodiment, scheduled and un-scheduled content can be shown in a Listings page for viewing and selection by a user. The Listings page of an example embodiment is described in more detail below.

From the Root page 1700, a user can also choose to select a ‘Search’ command option 1715, a ‘Settings’ command option 1716, or a ‘My Profile’ command option 1711. As described in more detail below, the ‘Search’ command option 1715 enables the user to search for a desired content item by using a Search page. The ‘Settings’ command option 1716 enables the user to view and manipulate a variety of parameters that can customize the operation and performance of the content browsing and selection system of various embodiments. The ‘My Profile’ command option 1711 enables the user to view and manipulate a variety of parameters that can define a portion of a user's profile. As shown in FIG. 17 (and others of the Figures), a highlight marker 1702 can be used to identify one of the available command options 1711, 1712, 1713, 1714, 1715, or 1716, which is currently available for selection and activation by the user. A pointing device or other control mechanism can be used to move the highlight marker 1702 to a desired command option. It will be apparent to those of ordinary skill in the art in view of this disclosure that the Root page 1700 can include other command options for user selection of other content sources or other content source types. For example, a user can also be given a command option to select from a set of personal content, including a personal video, audio, book, or document library by using a ‘Personal’ command option to select from a source of personal content.

Once a particular content source or content source type is selected by the user by using the Root page 1700, the service provider 110, as described above, can access a content catalog or content database 112 to obtain a list of one or more collections of content, content information and metadata associated with the content from the selected content source. If the content items or content information for the selected content source is not available in the content database 112, pre-defined links can be used to obtain the content items or content information for the selected content source. In this manner, the content items and the related content information for the selected content source can be made available for the user and displayed to the user in the manner detailed below for an example embodiment.

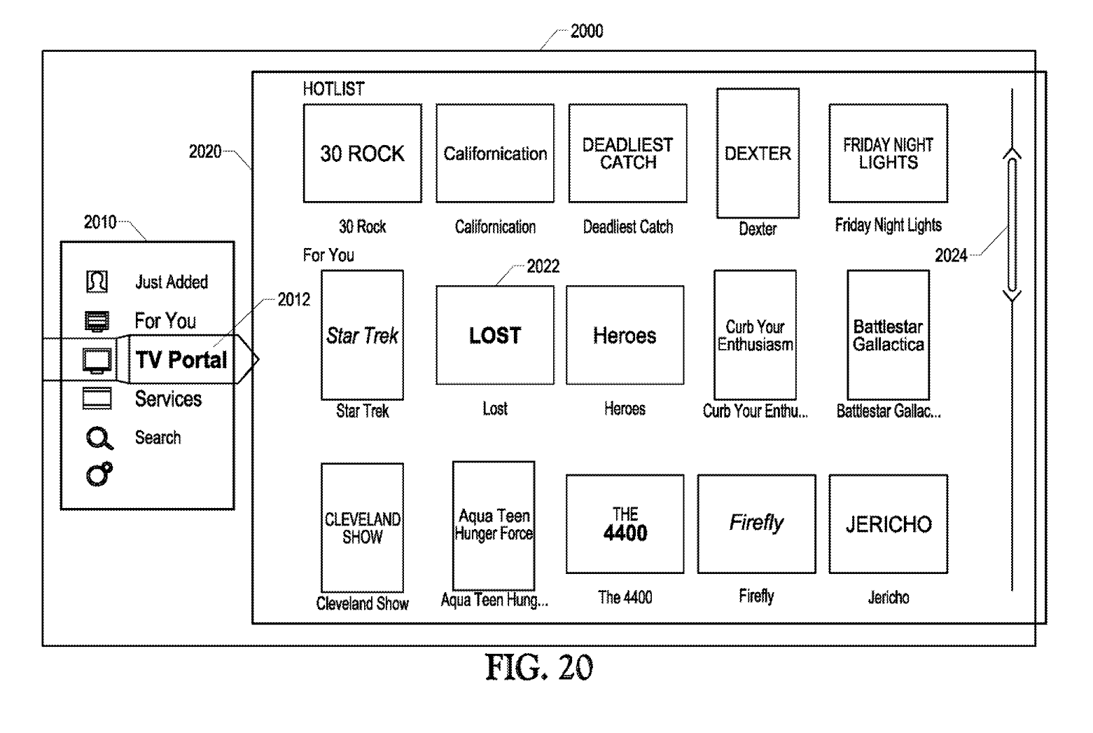

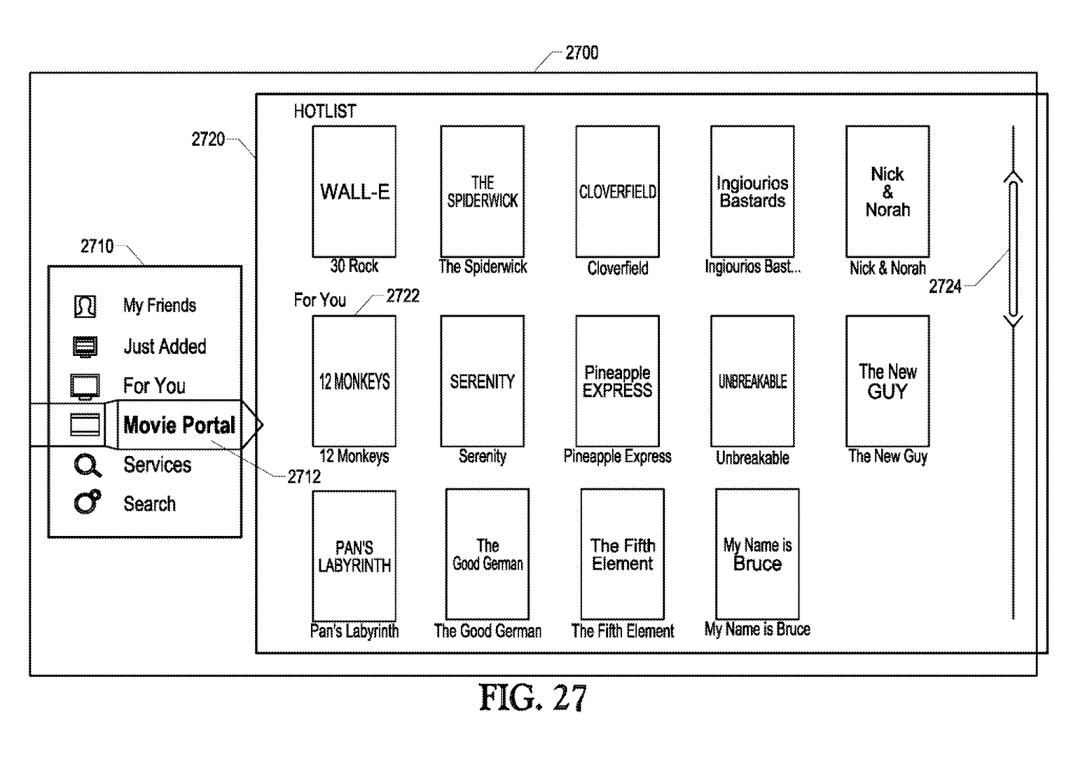

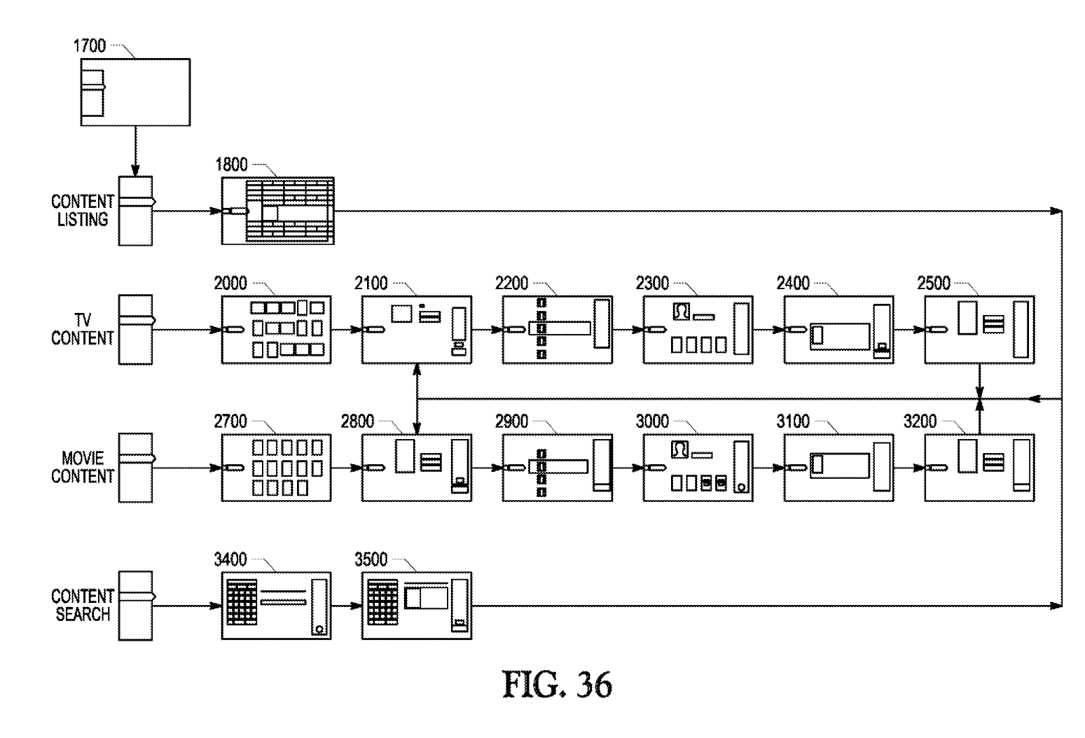

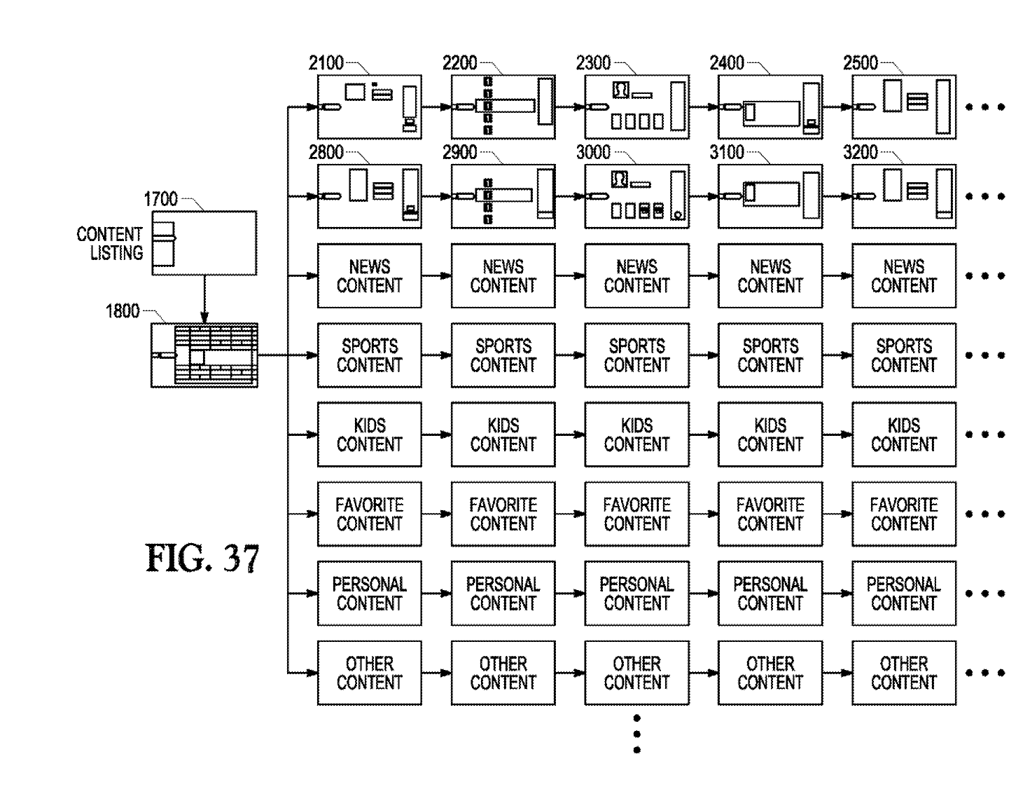

Referring now to the example shown in FIG. 18, the sample content browsing and selection user interface includes a Listings page 1800 that can be presented to the user in response to the user selecting the ‘Listing’ command option 1712 from Root page 1700. As shown in the example of FIG. 18, the Listings page 1800 provides a new set of command options in listing command option area 1810. These command options can include: Calendar, Favorites, All, News, Movies, Kids, Sports, Personal, etc. The available command options can be used to select a particular set of content listings that is displayed in content listing area 1820. In one embodiment, these content listings in content listing area 1820 are arranged in a grid with available content items (e.g., programming on channels, programming by content source, movie titles, song titles, sporting events, book or document titles, etc.) arranged in rows and time periods arranged in columns. Alternatively, the Listings page 1800 can be represented as a list of content items without an indication of time corresponding to availability of the content. In this embodiment, scheduled and un-scheduled content can be shown in a Listings page 1800 for viewing and selection by a user. It will be apparent to one of ordinary skill in the art in view of this disclosure that other embodiments can use an equivalent arrangement of content listings. The highlight marker 1802 can be used to identify one of the available command options in listing command option area 1810, which is currently available for selection and activation by the user. In the example shown in FIG. 18, the user has selected command option ‘All’ 1812, which can be used to display all available listings in content listing area 1820. The presentation of all available listings in content listing area 1820 can be used to list, group, sort, and/or consume content from a variety of content sources and/or channels, such as news content, movies, sports content, kids content, favorites, personal content, Internet content, and the like. The pointing device described above can also be used to identify portions of content or content information in content listing area 1820 that is of interest to the user. When the pointing device is moved in proximity to a particular content item listing in content listing area 1820, the particular content item listing is highlighted. The content information associated with the highlighted content item listing is displayed in an expanded form of the highlighted content item listing as shown in FIG. 18. The highlighted content item may be further selected for delivery and/or consumption. Alternatively, the user may receive additional content information and/or metadata. The content information is preferably navigable. For instance, television type content information is further described below in relation to FIG. 20. Movie type content information is further described below in relation to FIG. 27. The navigation of some embodiments is described in relation to FIGS. 36, 37, and 38. Again, a pointing device or other control mechanism can be used to move to a desired command option or content item listing.

Alternatively, a user can choose to select content from a variety of different content listing groupings, such as a content listing grouping represented by the ‘Favorites’ command option in command option area 1810. The ‘Favorites’ command option enables the user to pick content from a group of pre-defined user favorites. The user favorites can be content items explicitly specified by the user as favorite content items by using command options provided by the ‘Favorites’ functionality. Additionally, the user favorites can be content items implicitly identified by using recommendation engine 241 to gather user interest information, as described above, and to correlate user interests with corresponding content items and content information. Other content listing groupings can include news, sports, kids content, personal content, Internet content, and the like. An example structure and usage of the Listings page 1800 showing the program, “Lost”, for example, is described in more detail below in relation to FIGS. 36 and 37.

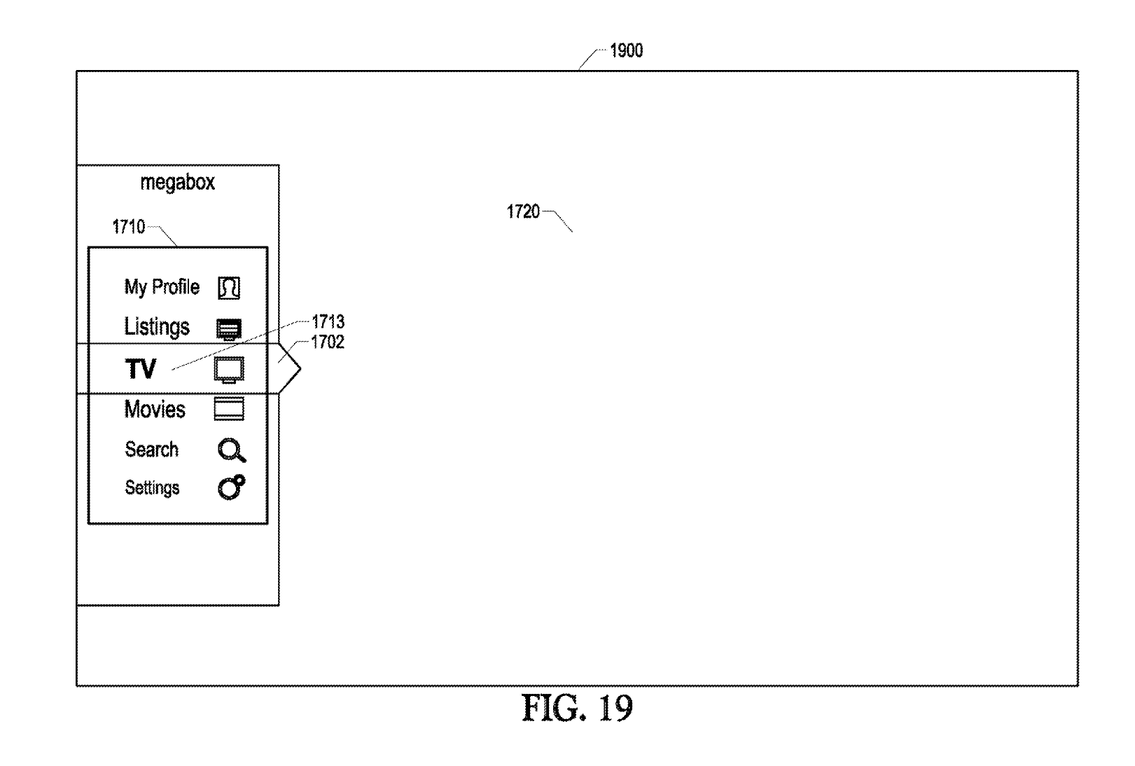

In a particular implementation, a user may browse content by using content information and/or metadata directly, and without a channel, a grid, and/or a listing. Referring now to the example shown in FIG. 19, a sample Root page 1900 is illustrated. In this example, the user has highlighted command option 1713 (TV') in command option area 1710 of the Root page 1900. The ‘TV’ command option enables the user to view a television (TV) content portal through which a variety of television programming content items may be accessed. These television programming content items can be broadcast programming, scheduled or unscheduled television programs, personal TV programming, Internet-based TV programming and the like. Upon selection of this command option 1713, the TV Portal 2000 can be displayed as shown in FIG. 20.

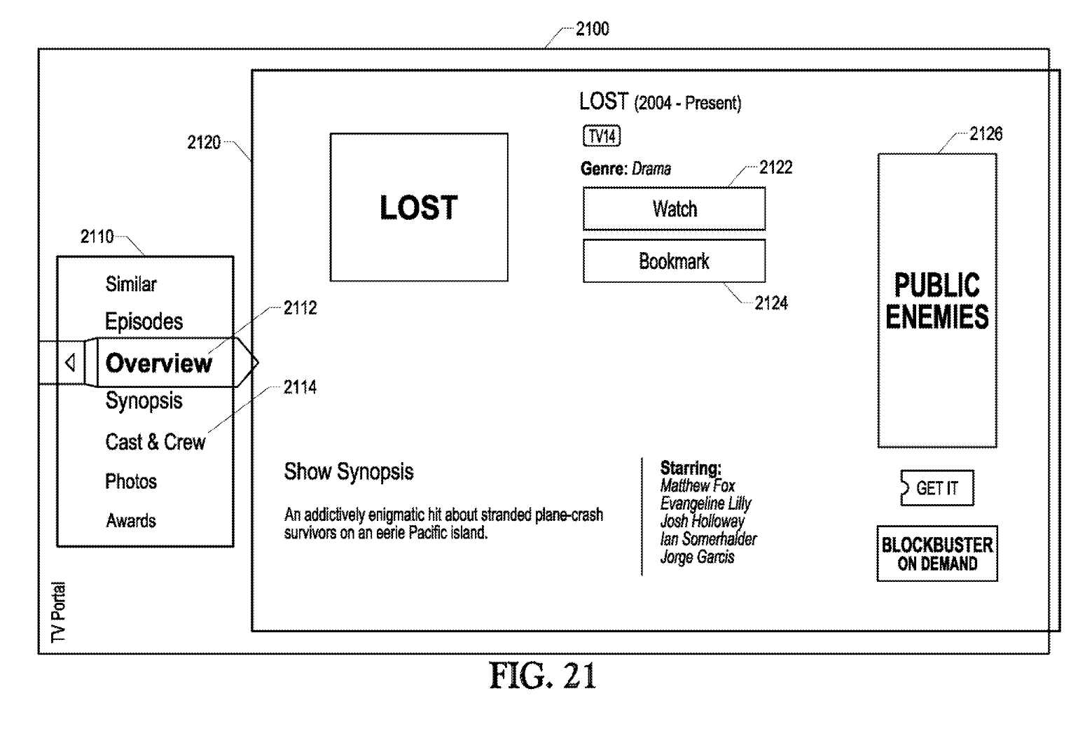

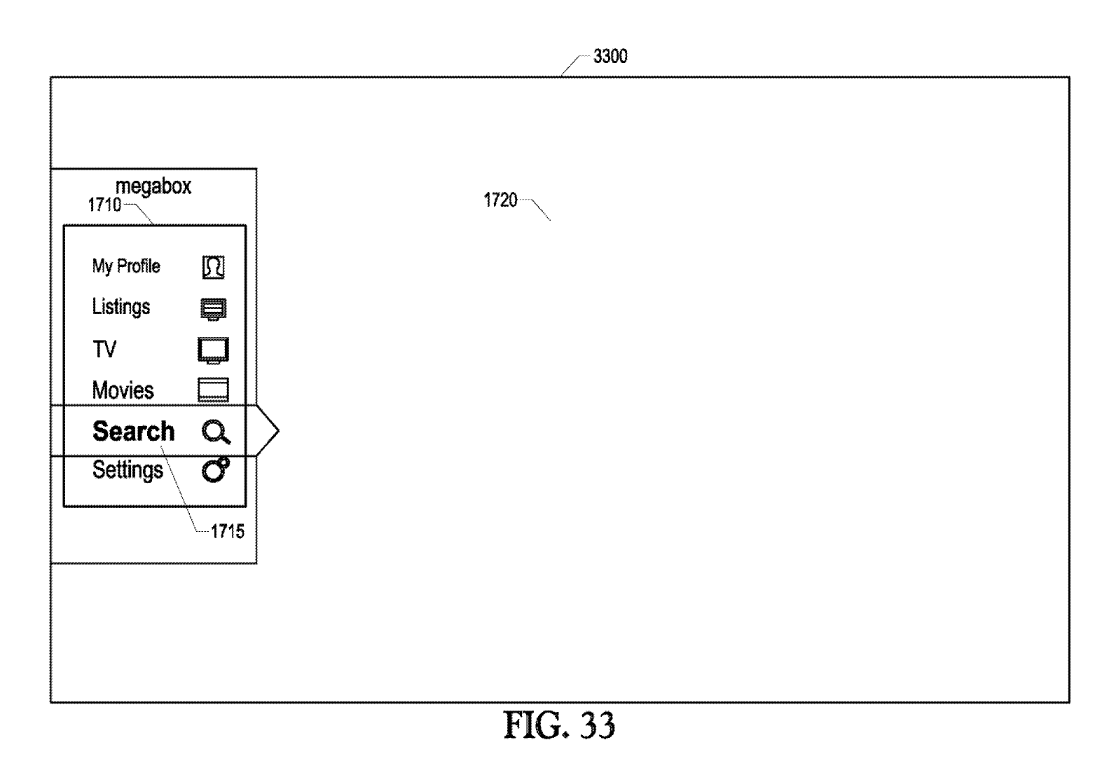

Referring now to the example shown in FIG. 20, the sample content browsing and selection user interface includes a TV Portal 2000 that can be presented to the user in response to the user selecting the ‘TV’ command option 1713 from Root page 1900. As described below, a user can employ other methods for accessing the TV Portal 2000. Once the TV Portal 2000 is selected by the user, the service provider 110, as described above, can access a content catalog or content database 112 to obtain a listing of one or more collections of content, content information and metadata associated with the television content for selection from the TV Portal 2000. If the content items or content information for the TV Portal 2000 are not available in the content database 112, pre-defined links can be used to obtain the content items or content information for the available television programming. In this manner, the content items and the related content information for the TV Portal 2000 can be made available for the user and displayed to the user in the manner illustrated in FIG. 20 for an example embodiment. Each television content item presented in TV Portal 2000 can include an image and/or a textual description of the particular TV content item. Each of the TV content items in content item area 2020 is user selectable. As shown, the user can manipulate the pointing device to position a selection box 2022 around any of the listed TV content items. A slider bar 2024 can be used to scroll the list of any arbitrary length for viewing in the content item area 2020. The user can select any of the listed TV content items by positioning the selection box 2022 around a desired TV content item and activating a selection button on a remote control device or other user platform signaling device. Upon selection of the desired TV content item by using selection box 2022, the TV Content Overview Page 2100 can be displayed as shown in FIG. 21. For example, the user in the example of FIG. 20 has selected the TV content item, “Lost” by using selection box 2022. As a result, the TV Content Overview Page 2100 can be displayed as shown in FIG. 21 to provide additional information and command options regarding the selected content item. As shown in the example of FIG. 20, the TV Portal 2000 also provides a new set of command options in command option area 2010. These command options can include: ‘TV Portal’, ‘Just Added’, ‘For You’, ‘Services’, and ‘Search’. The ‘TV Portal’ command option 2012 can be used to display a list of TV content items in content item area 2020 as shown in the example of FIG. 20. The ‘Just Added’ command option can be used to display a list of TV content items in content item area 2020 that have date/time information that is within a pre-defined threshold. The ‘For You’ command option can be used to display a list of TV content items in content item area 2020 that are likely of interest to a particular user/viewer based on a previously generated user profile and/or based on a history or pattern of previously viewed and/or consumed content. The ‘For You’ command option enables the user to pick TV content items from a group of television programming options automatically determined as likely of interest to the user by the recommendation engine 241. As explained above, the recommendation engine 241 can automatically assemble a list of TV content items of likely interest to a particular user based on the user interest information. The ‘Services’ command option can be used to display a list of TV related services available for selection in content item area 2020. The ‘Search’ command option can be used to invoke a search function and Search page for searching for particular TV content items that match a user entered search query. The search function of an example embodiment is explained in more detail below in regard to FIGS. 33 through 35. As mentioned above, upon selection of the desired TV content item by using selection box 2022, the TV Content Overview Page 2100 can be displayed as shown in FIG. 21. In this manner, the user can continue to explore the hierarchical dimensions of TV content information from a TV content portal page provided via the TV Portal 2000 as initiated, for example, through Root page 1900 shown in FIG. 19.

In a similar fashion, the user can also view the TV Content Overview Page 2100 for a particular content item from the Listings page 1800. In the example shown in FIG. 18, the user has selected command option ‘All’, and has highlighted a particular content listing 1822 in content listing area 1820, the highlighted content listing corresponding to the television program, ‘Lost.” As shown in FIG. 18, the user highlighting of the content listing 1822 causes more detailed and complete content information related to the highlighted content listing 1822 to be displayed in an expanded form in an expanded listing 1824. This expanded content listing 1824 can include a variety of additional content information or links to additional content information associated with the highlighted content listing 1822. Such additional content information can include images, additional descriptive text, rating information, closed captioning information, and the like. In an example embodiment, the expanded listing 1824, or the corresponding non-expanded content listing, can also include a command object 1826, which a user can select to obtain additional information related to the highlighted content listing 1822. As a result of activating command object 1826, the TV Content Overview Page 2100 shown in FIG. 21 can be displayed to the user. This page is described in detail below. Alternatively, the user can activate TV Content Overview Page 2100 by using a special button or command sequence on a remote control device or other user input device after highlighting a particular content item in a content listing. The TV Content Overview Page 2100 corresponding to a particular content item enables a user to obtain a deeper level of information and content selections related to a particular content item of interest. In a similar fashion, the user can also obtain a deeper level of information and content selections related to other types of content items in the Listings page 1800, such as movie content, audio content, and any other type of content provided in the Listings page 1800. As shown in the next several figures and described below, the user can manipulate the functionality described herein to probe deeply into a particular content item of interest and obtain access to various dimensions of information related to the content item.

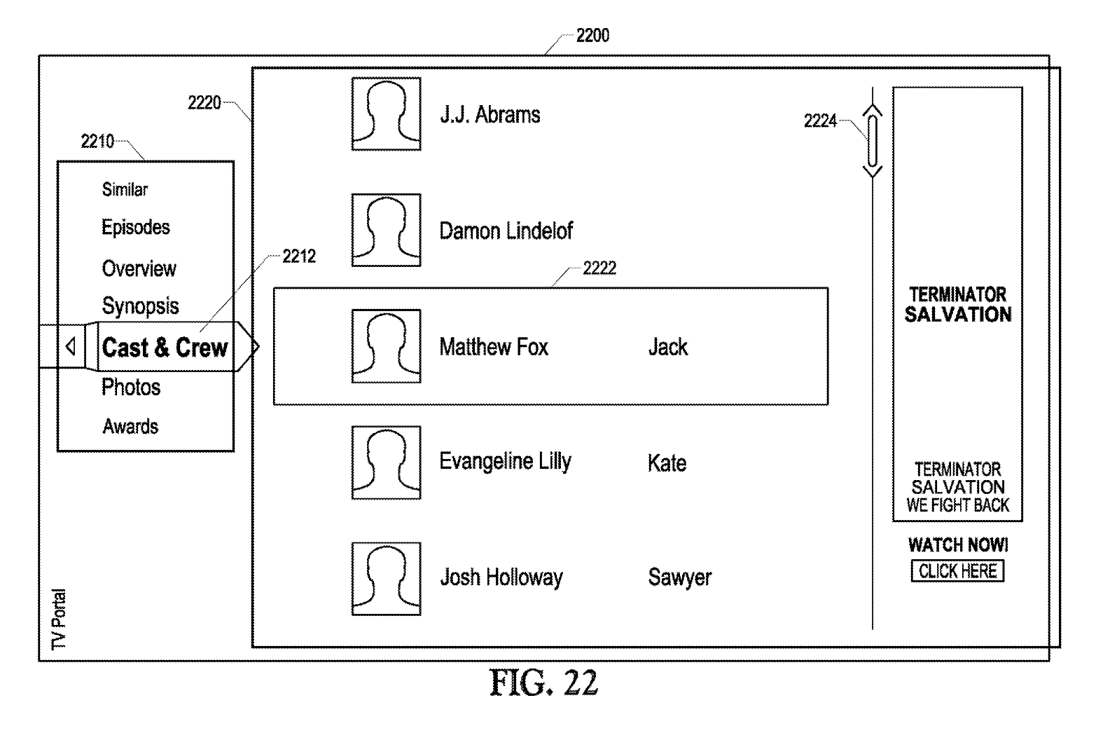

Referring now to the example shown in FIG. 21, the sample content browsing and selection user interface includes an overview of a particular content item (e.g., “Lost”) from the TV Portal 2000 as selected by a user via the TV Portal 2000 or the Listings page 1800. As described above, a user could have activated command object 1713 to cause the TV Portal 2000 shown in FIG. 20 to be displayed to the user. The user could also have activated command object 2022 in the TV Portal 2000 to cause the corresponding TV Content Overview Page 2100 to be displayed. Alternatively, the user could also have accessed the TV Content Overview Page 2100 via the Listings page 1800 as described above. The TV Content Overview Page 2100 provides a detailed set of information related to the selected content item in a content information area 2120. Additionally, the TV Content Overview Page 2100 provides a set of command options in a command option area 2110 for selecting among a set of dimensions of information corresponding to each of the command options. A similarly structured content overview page can be provided for any content item available for selection by a user. These dimensions of information enable a user to probe more deeply into a particular area of interest related to a selected content item. For example, command option area 2110 can include command options such as: Overview, Synopsis, Cast & Crew, Photos, Awards, Episodes, and Similar. The Overview command option 2112 presents an overview of information related to the selected content item. A sample of such information is shown in content information area 2120 of FIG. 21. The overview information can include a synopsis of the content item, an image, a list of the cast, rating and genre information, a description, summary, or abstract of the plot or subject matter associated with the selected content item. The image may include an album cover, screen shot, or another type of image for identifying the content item and/or the content information and/or metadata. Other information can include a rating, genre, category, run time, ranking, date, video and/or audio resolution, and the like as associated with the particular content item. The sets of information associated with the selected content item can also include a listing of the personnel associated with the content item, such as director, producer, cast, author, performer, writer, composer, and the like. The sets of information associated with the selected content item can also include one or more images associated with the content item. These images can depict still images of scenes from the movie, pictures of the actors, performers, or songwriters, or other memorable images reminiscent of the particular content item. The sets of information associated with the selected content item can also include a list of awards or credits received by the content item or its originators. The sets of information associated with the selected content item can also include a listing of the sources from which the content item can be obtained for viewing, listening, purchase, rent, or otherwise. The sets of information associated with the selected content item can also include a selectable command option or user-selectable button for requesting a viewing of a trailer of the selected content item. In response to a selection of this command option, all or a portion of the content information area 1720 of FIG. 19 can be replaced with a video window for displaying a trailer associated with the selected content item. Additionally, the overview information can include a user-selectable button 2122 to enable the user to watch, listen, or otherwise consume the selected content item, and a user-selectable button 2124 to enable the user to bookmark the content item for easy access or to add the content item to a list of favorite content items. Additionally, the overview information can include a user-selectable button to enable the user to provide a user-entered rating and/or ranking of the selected content item. In response to a selection of this user-selectable rating and/or ranking button, the user's rating and/or ranking of the selected content item can be added to a global pool of content rating and/or ranking data collected from a plurality of users and maintained by the processing system 200. The global pool of content rating and/or ranking data can be used by the recommendation engine 241 when preparing the list of recommended content for a particular user. It will be apparent to those of ordinary skill in the art in view of this disclosure that a variety of additional information and command selections related to the particular content item can be equivalently provided. Additionally, advertising or other commercial content 2126 can be displayed in the content information area 2120 to produce revenue when the content information area 2120 is displayed to a user. Each of these command options in command option area 2110 can be selected by a user to obtain further information related to a selected content item in a particular dimension. By way of example, the user may choose to get more information regarding the cast and crew of a particular selected content item. In this case, for example, the user can select the command option 2114. As a result of the selection of the command option 2114, the Cast page 2200 can be displayed as shown in FIG. 22.

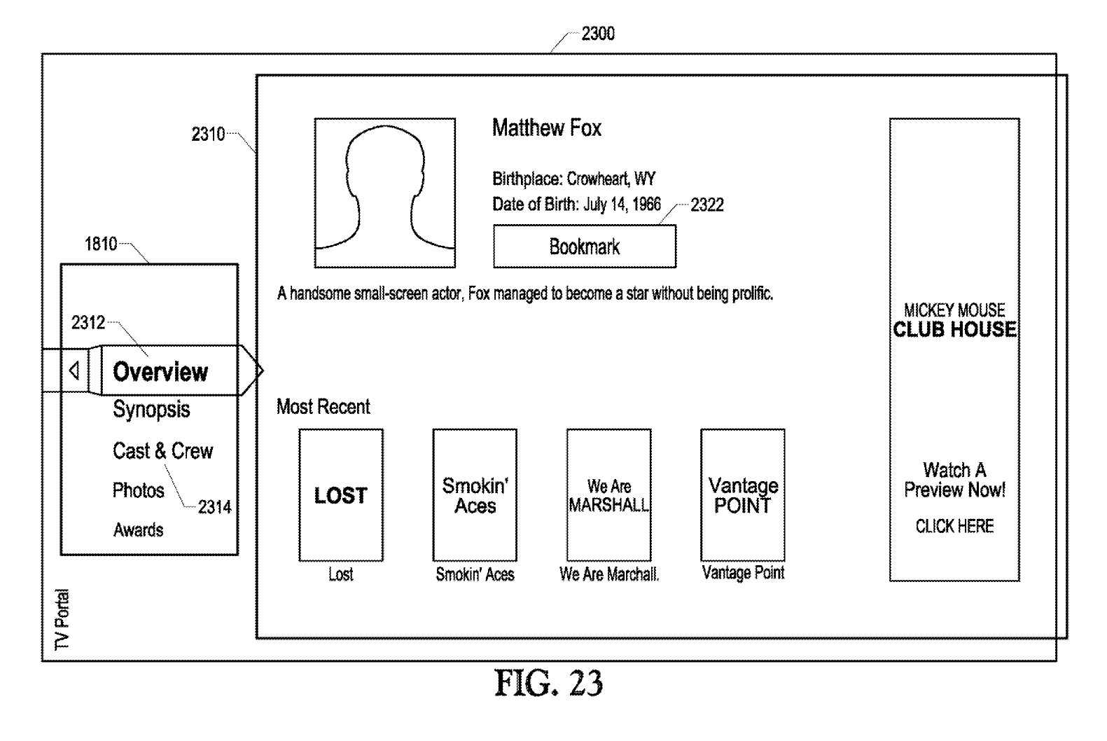

Referring now to the example shown in FIG. 22, the sample content browsing and selection user interface includes Cast page 2200, which can be displayed as a result of a user selecting the command option 2114 from TV Content Overview Page 2100. The corresponding command selection 2212 is shown in FIG. 22. The Cast page 2200 represents one dimension (of a plurality of available dimensions) of detailed information related to a selected content item, in this example, the “Lost” television program. In the example of FIG. 22, the identities of the cast and crew (personnel identities) associated with the selected content item are listed in the information area 2220. As shown, the user can manipulate the pointing device to position a selection box 2222 around any of the listed personnel identities. A slider bar 2224 can be used to scroll the list of any arbitrary length for viewing in the information area 2220. The user can select any of the listed personnel identities by positioning the selection box 2222 around a desired personnel identity and activating a selection button on a remote control device or other user platform signaling device. Upon selection of the desired personnel identity by using selection box 2222, the Actor page 2300 can be displayed as shown in FIG. 23.

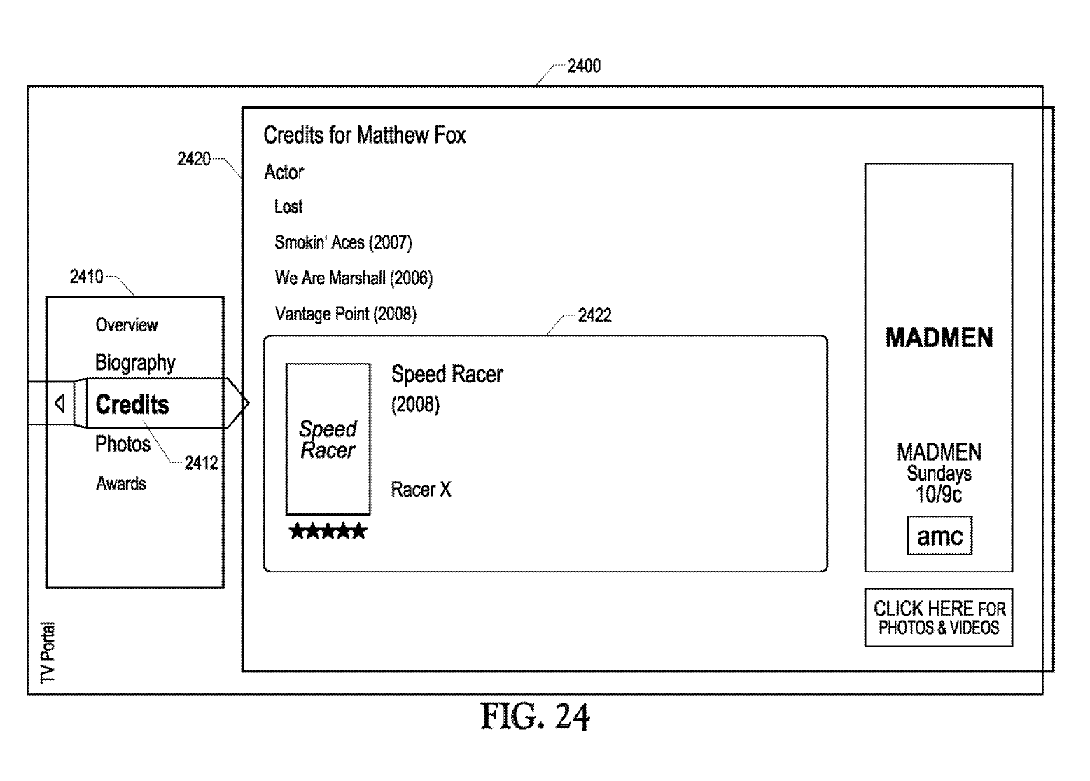

Referring now to the example shown in FIG. 23, the sample content browsing and selection user interface includes Actor page 2300, which can be displayed as a result of a user selection of the desired personnel identity by using selection box 2222 from Cast page 2200. The Actor page 2300 represents a new dimension (of a plurality of available dimensions) of detailed information related to a selected content item, in this example, the “Lost” television program and a selected personnel identity associated with the selected content item, in this example, ‘Matthew Fox’. Note that the detailed information related to the selected content item is arranged hierarchically, given that the detailed information in a particular dimension is accessed by the user through a plurality of command selections. In this manner, the user is only given the detailed information s/he has requested. Thus, the user does not need to sift through a large set of detailed information to find the particular information desired. In the example of FIG. 23, detailed information related to the selected personnel identity of the selected content item is shown in information area 2320. A new set of command options are provided in command option area 2310 as shown in FIG. 23. The available command options in command option area 2310 enable the user to probe more deeply in the various dimensions of detailed information related to the selected personnel identity. For example, command option 2312 ('Overview') provides an overview of detailed information available for the selected personnel identity. This overview of detailed information is shown in the example of information area 2320 shown in FIG. 23. The detailed information provided in information area 2320 can include background information related to the selected person, links to other content items with which the selected person is associated, links to other people with which the selected person is associated, links to other websites with which the selected person is associated, command options, such as command option 2322 to enable the user to bookmark a page associated with the selected person, command options to play video or audio clips related to the selected person, and the like. The available command options in command option area 2310 can include other command options to enable the user to explore other dimensions of detailed information related to the selected personnel identity. For example, these other command options can include an, ‘Overview’, ‘Biography’, ‘Credits’, ‘Photos’, or ‘Awards’ command option to enable the user to explore these dimensions of detailed information related to the selected personnel identity. It will be apparent to those of ordinary skill in the art in view of this disclosure that other dimensions of detailed information related to the selected personnel identity can be similarly provided. Each command option in command option area 2310 represents a different dimension of detailed information related to the selected personnel identity. In a particular example embodiment, a command option 2314 ('Credits') can be selected by a user by manipulation of the pointing device and positioning of the highlight marker 2302 in proximity to the command option 2314. It will be apparent to those of ordinary skill in the art in view of this disclosure that any of the other available command options in command option area 2310 can be similarly selected. Upon selection of the command option 2314, the Credits page 2400 can be displayed as shown in FIG. 24.

Referring now to the example shown in FIG. 24, the sample content browsing and selection user interface includes Credits page 2400, which can be displayed as a result of a user selection of the command option 2314 from Actor page 2300. The Credits page 2400 represents yet another dimension (of a plurality of available dimensions) of detailed information related to a selected content item, in this example, the “Lost” television program, a selected personnel identity associated with the selected content item, in this example, ‘Matthew Fox’, and credit information (e.g., other content items with which the selected person is associated) corresponding to the selected personnel identity. Again, note that the detailed information (actor credits information in this case) related to the selected content item is arranged hierarchically, relative to other detailed information associated with the selected content item. In the example of FIG. 24, detailed information related to the credits of the selected personnel identity of the selected content item is shown in information area 2420. The detailed information provided in information area 2420 can include a list of different content items (e.g., movies, programs, events, musical compositions, etc.) with which the selected person is associated, links to different content items with which the selected person is associated, links to other people with which the selected person is associated, links to other websites with which the selected person is associated, and command options to access associated content items, people, websites, and the like. In this case, the actor “Matthew Fox” in the television content “Lost” is also shown to portray the character “Racer X” in the movie content item “Speed Racer.” Accordingly, a user advantageously navigates content of various types by using content information and/or metadata of various types. The content information and/or metadata further have graduated degrees of relevance.

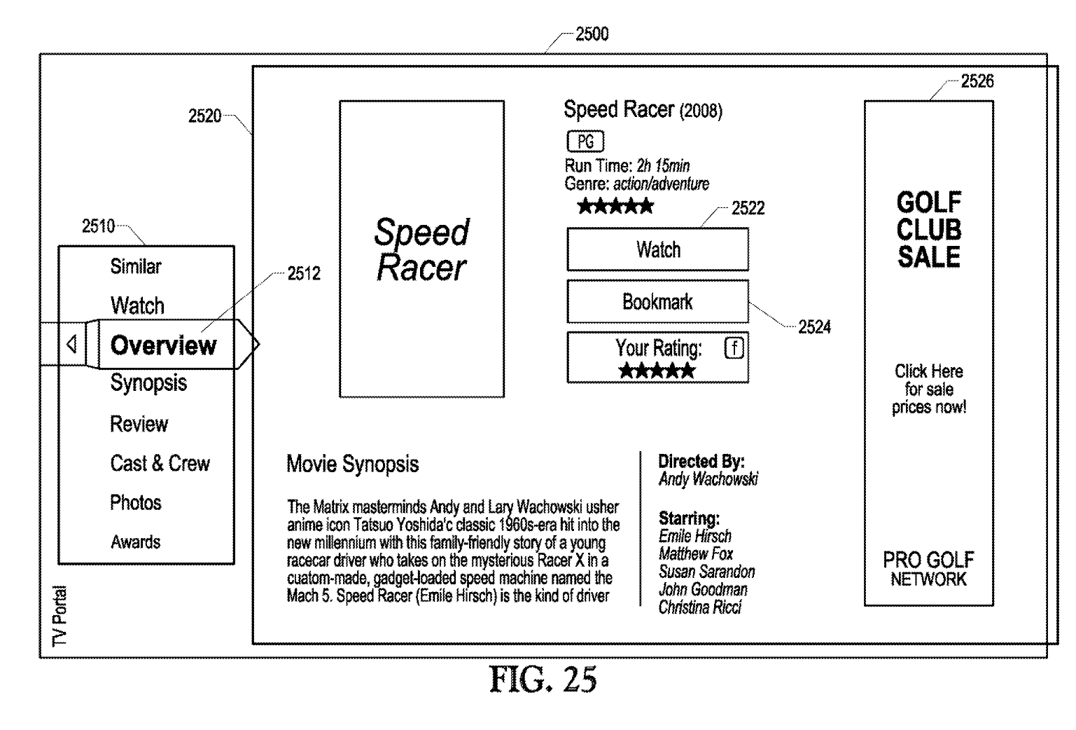

The available command options in command option area 2410 can include other command options to enable the user to explore other dimensions of detailed credit information related to the selected personnel identity. For example, these other command options can include an, ‘Overview’, ‘Biography’, ‘Credits’, ‘Photos’, or ‘Awards’ command option to enable the user to explore these dimensions of detailed credit information related to the selected personnel identity. It will be apparent to those of ordinary skill in the art in view of this disclosure that other dimensions of detailed credit information related to the selected personnel identity can be similarly provided. Each command option in command option area 2410 represents a different dimension of detailed credit information related to the selected personnel identity. In a particular example embodiment, command option 2412 ('Credits') was selected by a user, which resulted in the detailed credit information being displayed in the information area 2420. It will be apparent to those of ordinary skill in the art in view of this disclosure that any of the other available command options in command option area 2410 can be similarly selected. As shown in FIG. 24, the user can manipulate the pointing device to position a selection box 2422 around or in proximity to any of the listed credit information items (e.g., different content items associated with the selected personnel identity). The user can select any of the listed credits information items by positioning the selection box 2422 around or near a desired credits information item and activating a selection button on a remote control device or other user platform signaling device. Upon selection of the desired credits information item by using selection box 2422, the Movie Overview page 2500 can be displayed as shown in FIG. 25.

Referring now to the example shown in FIG. 25, the sample content browsing and selection user interface includes Movie Overview page 2500, which can be displayed as a result of a user selection of a desired credits information item 2422 from Credits page 2400. In this example, the desired credits information item 2422 corresponds to a different content item that is related to the selected personnel identity. The Movie Overview page 2500 represents yet another dimension (of a plurality of available dimensions) of detailed information related to a selected content item, in this example, the “Lost” television program, a selected personnel identity associated with the selected content item, in this example, ‘Matthew Fox’, and a different content item associated with the selected personnel identity, in this example, the movie ‘Speed Racer’, starring Matthew Fox. Again, note that the detailed information (a different content item associated with the selected personnel identity, in this case) related to the selected content item is arranged hierarchically, relative to other detailed information associated with the selected content item. Also note that the same or similar Movie Overview page 2500 can be accessed via the Movie Portal as described in more detail below. In the example of FIG. 25, Movie Overview page 2500 provides a detailed set of information related to the different content item in a content area 2520. Additionally, Movie Overview page 2500 provides a set of command options in a command option area 2510 for selecting among a set of dimensions of information corresponding to each of the command options. These dimensions of information enable a user to probe more deeply into a particular area of interest related to the selected different content item. For example, command option area 2510 can include command options such as: Overview, Synopsis, Review, Cast & Crew, Photos, Awards, Watch, and Similar. The Overview command presents an overview of information related to the selected different content item. A sample of such information is shown in information area 2520 of FIG. 25. The overview information can include a synopsis of the different content item, an image, a list of the cast, rating and genre information, a user-selectable button 2522 to enable the user to watch, listen, or otherwise consume the different content item, and a user-selectable button 2524 to enable the user to bookmark the different content item for easy access. In this disclosure, a variety of additional information and command selections related to the particular content item can be equivalently provided. Additionally, advertising or other commercial content 2526 can be displayed in the information area 2520 to produce revenue when the information area 2520 is displayed to a user. Each of these command options in command option area 2510 can be selected by a user to obtain further information related to a different content item in a particular dimension. In this manner, the user can continue to explore the hierarchical dimensions of content information from a TV Portal page provided via the TV Portal 2000 as initiated through the Root page 1900 shown in FIG. 19.

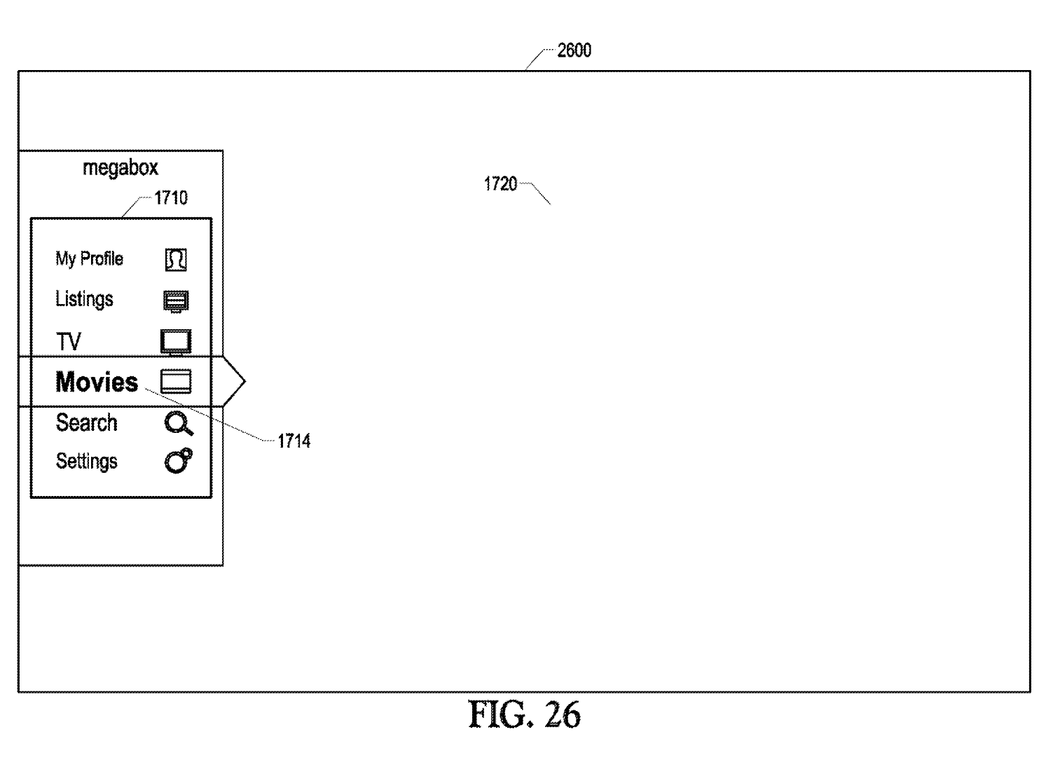

Referring now to the example shown in FIG. 26, the sample Root page 2600 is illustrated. In this example, the user has highlighted command option 1714 (Movies') in command option area 1710 of the Root page 2600. The ‘Movies’ command option enables the user to view a movie content portal through which a variety of movie content items may be accessed. Upon selection of this command option, the Movie Portal 2700 can be displayed as shown in FIG. 27.

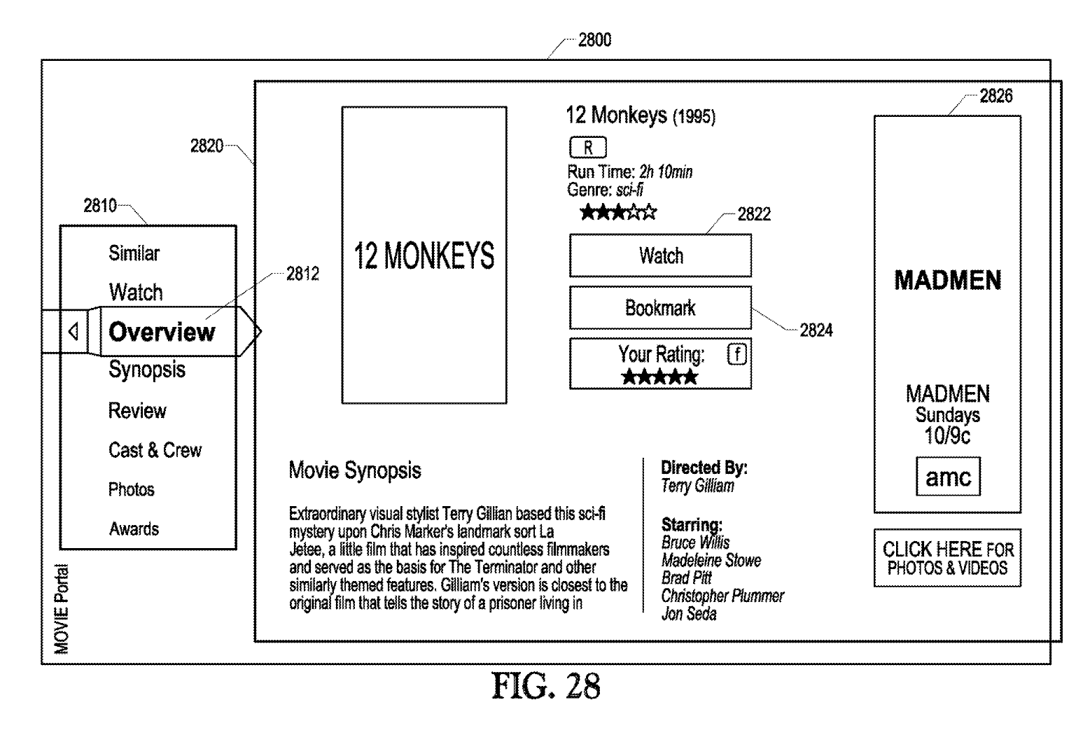

Referring now to the example shown in FIG. 27, the sample content browsing and selection user interface includes a Movie Portal 2700 that can be presented to the user in response to the user selecting the ‘Movies’ command option 1714 from Root page 2600. As described herein, a user can employ other methods for accessing the Movie Portal 2700. Once the Movie Portal 2700 is selected by the user, the service provider 110, as described above, can access a content catalog or content database 112 to obtain a listing of one or more collections of movie content, content information and metadata associated with the movie content for selection from the Movie Portal 2700. If the content items or content information for the Movie Portal 2700 is not available in the content database 112, pre-defined links can be used to obtain the content items or content information for the available movie titles. In this manner, the content items and the related content information for the Movie Portal 2700 can be made available for the user and displayed to the user in the manner illustrated in FIG. 27 for an example embodiment. Each movie content item presented in Movie Portal 2700 can include an image and/or a textual description of the particular movie content item. In the example embodiment shown in FIG. 27, each user-selectable movie content item in a content area 2720 is represented as a view of a movie DVD (digital versatile disk) jacket, DVD/CD (compact disk) case, album cover, book cover, or the like including a graphical image consistent with the actual image provided on a physical version of the corresponding content selection. By rendering the various content items in this manner, a user is more easily able to select a particular content item based in part on a familiar image associated with the content in addition to the textual identifier for each content item. If no graphical image consistent with an actual image provided on a physical version of the corresponding content selection is available, a user-selectable image can be associated with a particular content item to enable a user to associate a familiar image with the particular content item. Each of the movie content items in content item area 2720 is user selectable. As shown, the user can manipulate the pointing device to position a selection box 2722 around any of the listed movie content items. A slider bar 2724 can be used to scroll the list of any arbitrary length for viewing in the content item area 2720. The user can select any of the listed movie content items by positioning the selection box 2722 around a desired movie content item and activating a selection button on a remote control device or other user platform signaling device. Upon selection of the desired movie content item by using selection box 2722, the Movie Overview page 2800 can be displayed as shown in FIG. 28. For example, the user in the example of FIG. 27 has selected the movie content item, “12 Monkeys” by using selection box 2722. As a result, the corresponding Movie Overview page 2800 can be displayed as shown in FIG. 28 to provide additional information and command options regarding the selected content item as explained in more detail below.

As shown in the example of FIG. 27, the Movie Portal 2700 also provides a new set of command options in movie portal command option area 2710. These command options can include: ‘Movie Portal’, ‘Just Added’, ‘For You’, ‘My Friends’, ‘Services’, and ‘Search’. The ‘Movie Portal’ command option 2712 can be used to display a list of movie content items in content item area 2720 as shown in the example of FIG. 27. The ‘Just Added’ command option can be used to display a list of movie content items in content item area 2720 that have date/time information that is within a pre-defined threshold. The ‘For You’ command option can be used to display a list of movie content items in content item area 2720 that are likely of interest to a particular user/viewer based on a previously generated user profile and/or based on a history or pattern of previously viewed and/or consumed content. The ‘For You’ command option enables the user to pick movie content items from a group of movie options automatically determined as likely of interest to the user by the recommendation engine 241. As explained above, the recommendation engine 241 can automatically assemble a list of movie content items of likely interest to a particular user based on the user interest information. The ‘My Friends’ command option can be used to display a list of movie content items in content item area 2720 that are likely of interest to a particular user/viewer based on recommendations by friends of the user/viewer. The ‘Services’ command option can be used to display a list of movie related services available for selection in content item area 2720. The ‘Search’ command option can be used to invoke a search function for searching for particular movie content items that match a user entered search query. The search function of an example embodiment is explained in more detail below in regard to FIGS. 33 through 35. Upon selection of the desired movie content item by using selection box 2722, the Movie Overview page 2800 can be displayed as shown in FIG. 28. In this manner, the user can continue to explore the hierarchical dimensions of movie content information from a movie content portal page provided via the Movie Portal 2700 as initiated through Root page 2600 shown in FIG. 26. Note that the Movie Overview page 2800 can also be accessed via the Listings page 1800 as described above.

Referring now to the example shown in FIG. 28, the sample content browsing and selection user interface includes Movie Overview page 2800, which can be displayed as a result of a user selection of a desired movie content item 2722 from Movie Portal 2700. The Movie Overview page 2800 represents a new dimension (of a plurality of available dimensions) of detailed information related to a selected content item, in this example, the “12 Monkeys” movie. Again, note that the detailed information (associated with a selected movie, in this case) is arranged hierarchically, relative to other detailed information associated with the selected content item. In the example of FIG. 28, Movie Overview page 2800 provides a detailed set of information related to the selected content item in a content area 2820. Additionally, Movie Overview page 2800 provides a set of command options in a command option area 2810 for selecting among a set of dimensions of information corresponding to each of the command options. These dimensions of information enable a user to probe more deeply into a particular area of interest related to the selected content item. For example, command option area 2810 can include command options such as: Overview, Synopsis, Review, Cast & Crew, Photos, Awards, Watch, and Similar. The Overview command 2812 presents an overview of information related to the selected content item. A sample of such information is shown in content area 2820 of FIG. 28. The Overview information can include a synopsis of the content item, an image, a list of the cast, rating and genre information, a user-selectable button 2822 to enable the user to watch, listen, or otherwise consume the content item, and a user-selectable button 2824 to enable the user to bookmark the content item for easy access. It will be apparent to those of ordinary skill in the art in view of this disclosure that a variety of additional information and command selections related to the particular content item can be equivalently provided. Additionally, advertising or other commercial content 2826 can be displayed in the content area 2820 to produce revenue when the content area 2820 is displayed to a user. Each of these command options in command option area 2810 can be selected by a user to obtain further information related to a content item in a particular dimension. In this manner, the user can continue to explore the hierarchical dimensions of content information from a movie overview page provided via the Movie Portal 2700 as initiated through Root page 2600 shown in FIG. 26.

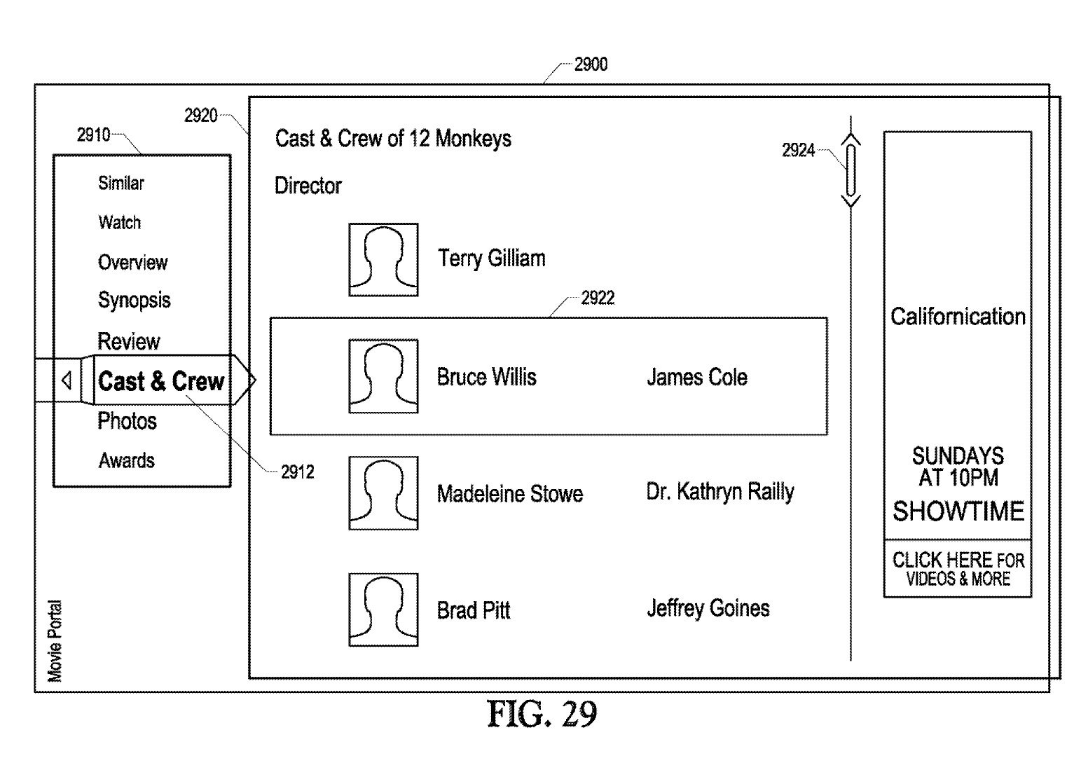

Referring now to the example shown in FIG. 29, the sample content browsing and selection user interface includes Cast page 2900, which can be displayed as a result of a user selecting the command option 2814 from Movie Overview page 2800. The corresponding command selection 2912 is shown in FIG. 29. The Cast page 2900 represents one dimension (of a plurality of available dimensions) of detailed information related to a selected content item, in this example, the “12 Monkeys” movie. The content information further has varying degrees of relevance to the subject content item, and to the previously browsed content item(s).

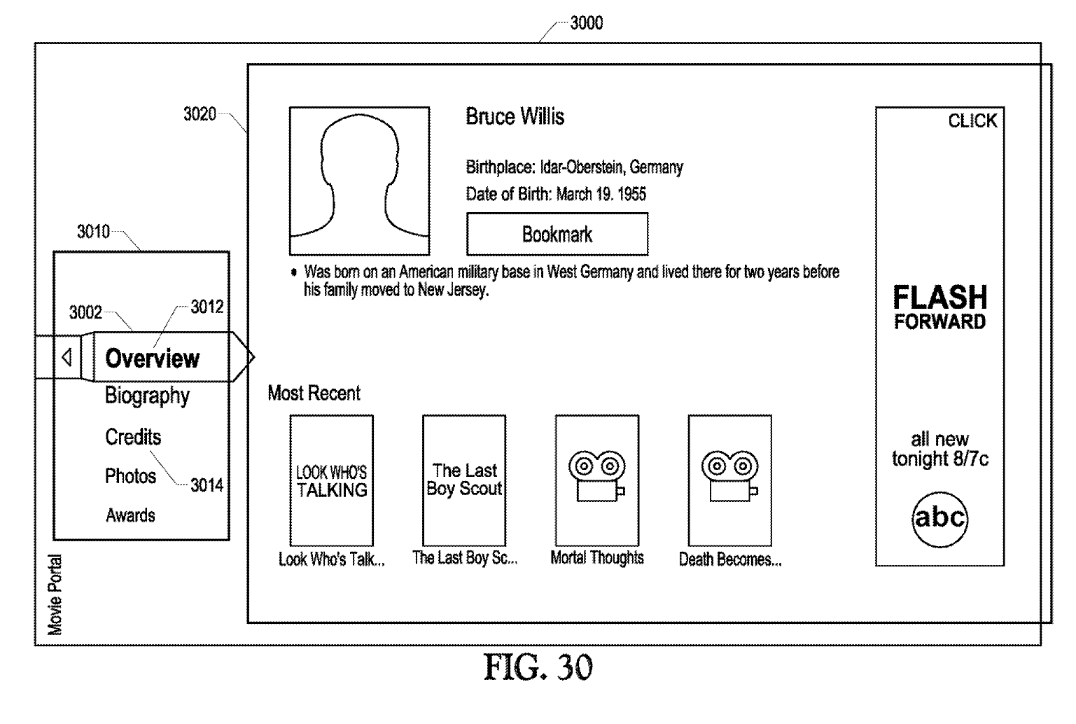

In the example of FIG. 29, the identities of the cast and crew (personnel identities) associated with the selected content item are listed in information area 2920. As shown, the user can manipulate the pointing device to position a selection box 2922 around any of the listed personnel identities. A slider bar 2924 can be used to scroll the list of any arbitrary length for viewing in the information area 2920. The user can select any of the listed personnel identities by positioning the selection box 2922 around a desired personnel identity and activating a selection button on a remote control device or other user platform signaling device. Upon selection of the desired personnel identity by using selection box 2922, the Actor page 3000 can be displayed as shown in FIG. 30.

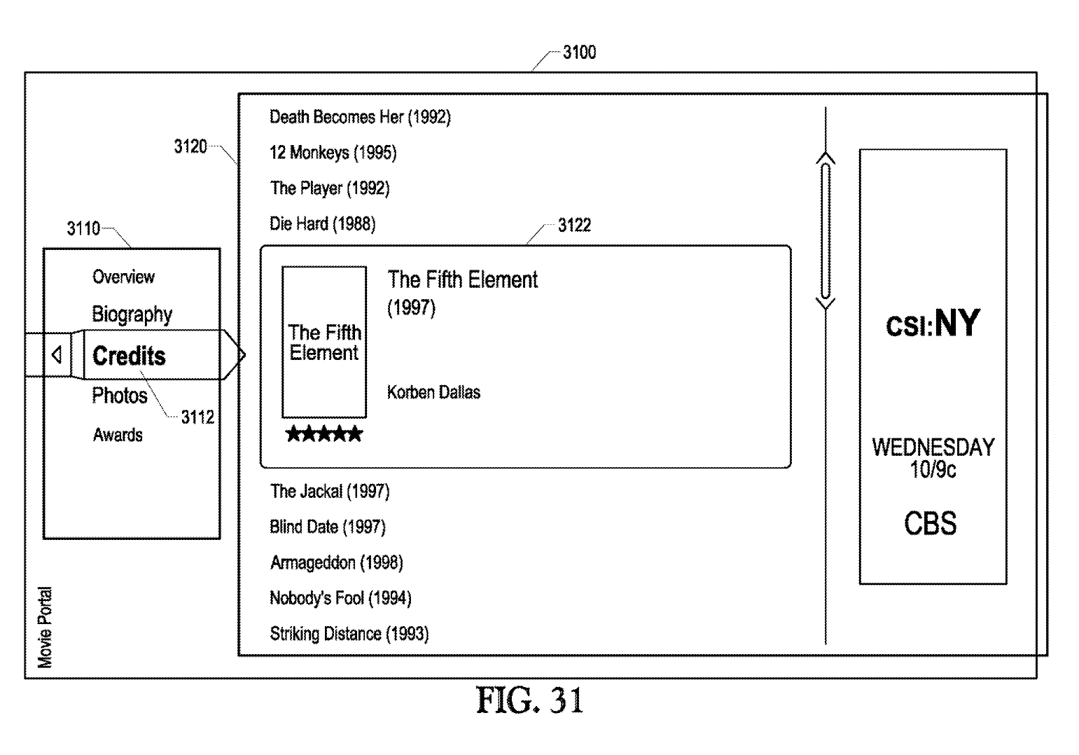

Referring now to the example shown in FIG. 30, the sample content browsing and selection user interface includes Actor page 3000, which can be displayed as a result of a user selection of the desired personnel identity by using selection box 2922 from Cast page 2900. The Actor page 3000 represents a new dimension (of a plurality of available dimensions) of detailed information related to a selected content item, in this example, the “12 Monkeys” movie and a selected personnel identity associated with the selected content item, in this example, ‘Bruce Willis’. Note that the detailed information related to the selected content item is arranged hierarchically, given that the detailed information in a particular dimension is accessed by the user through a plurality of command selections. In this manner, the user is advantageously given the detailed information s/he has requested. In the example of FIG. 30, detailed information related to the selected personnel identity of the selected content item is shown in information area 3020. A new set of command options are provided in command option area 3010 as shown in FIG. 30. The available command options in command option area 3010 enable the user to probe more deeply in the various dimensions of detailed information related to the selected personnel identity. For example, command option 3012 ('Overview') provides an overview of detailed information available for the selected personnel identity. This overview of detailed information is shown in the example of information area 3020 shown in FIG. 30. The detailed information provided in information area 3020 can include background information related to the selected person, links to other content items with which the selected person is associated, links to other people with which the selected person is associated, links to other websites with which the selected person is associated, command options, such as command option 3022 to enable the user to bookmark a page associated with the selected person, command options to play video or audio clips related to the selected person, and the like. The available command options in command option area 3010 can include other command options to enable the user to explore other dimensions of detailed information related to the selected personnel identity. For example, these other command options can include an, ‘Overview’, ‘Biography’, ‘Credits’, ‘Photos’, or ‘Awards’ command option to enable the user to explore these dimensions of detailed information related to the selected personnel identity. It will be apparent to those of ordinary skill in the art in view of this disclosure that other dimensions of detailed information related to the selected personnel identity can be similarly provided. Each command option in command option area 3010 represents a different dimension of detailed information related to the selected personnel identity. In a particular example embodiment, a command option 3014 ('Credits') can be selected by a user by manipulation of the pointing device and positioning of the highlight marker 3002 in proximity to the command option 3014. It will be apparent to those of ordinary skill in the art in view of this disclosure that any of the other available command options in command option area 3010 can be similarly selected. Upon selection of the command option 3014, the Credits page 3100 can be displayed as shown in FIG. 31.

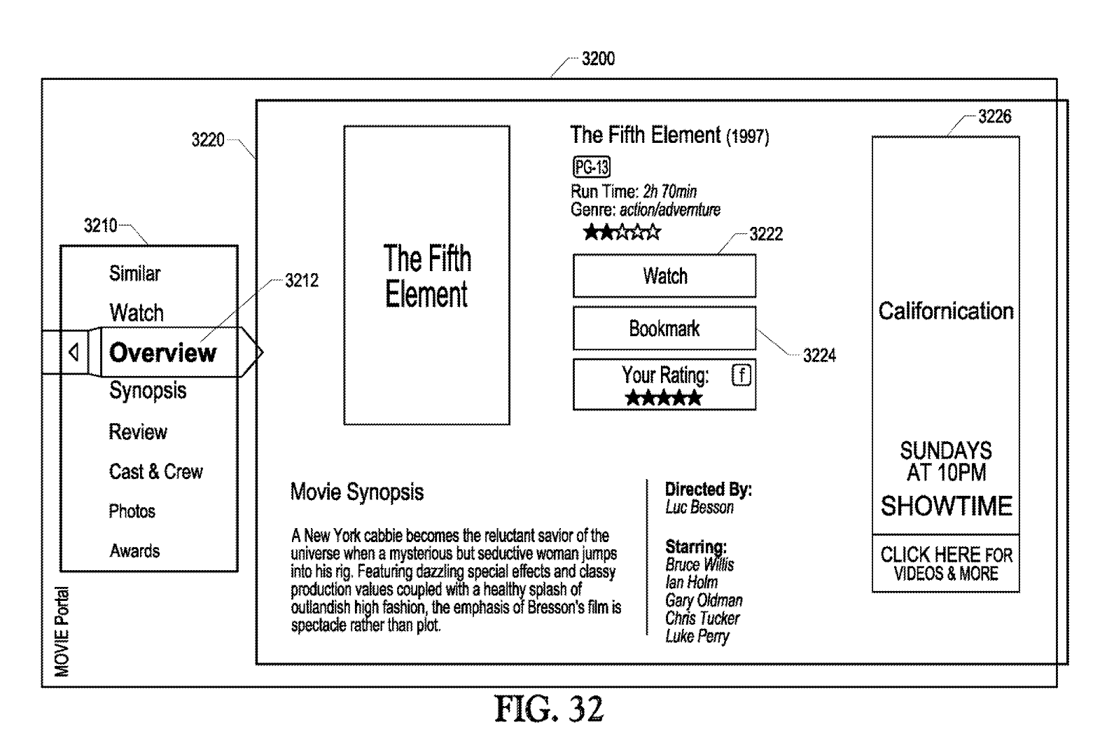

Referring now to the example shown in FIG. 31, the sample content browsing and selection user interface includes Credits page 3100, which can be displayed as a result of a user selection of the command option 3014 from Actor page 3000. The Credits page 3100 represents yet another dimension (of a plurality of available dimensions) of detailed information related to a selected content item, in this example, the “12 Monkeys” movie, a selected personnel identity associated with the selected content item, in this example, ‘Bruce Willis’, and credit information (e.g., other content items with which the selected person is associated) corresponding to the selected personnel identity. Again, note that the detailed information (actor credit information in this case) related to the selected content item is arranged hierarchically, relative to other detailed information associated with the selected content item. In the example of FIG. 31, detailed information related to the credits of the selected personnel identity of the selected content item is shown in information area 3120. The detailed information provided in information area 3120 can include a list of different content items (e.g., movies, programs, events, musical compositions, etc.) with which the selected person is associated, links to different content items with which the selected person is associated, links to other people with which the selected person is associated, links to other websites with which the selected person is associated, and command options to access associated content items, people, websites, and the like. The available command options in command option area 3110 can include other command options to enable the user to explore other dimensions of detailed credit information related to the selected personnel identity. For example, these other command options can include an, ‘Overview’, ‘Biography’, ‘Credits’, ‘Photos’, or ‘Awards’ command option to enable the user to explore these dimensions of detailed credit information related to the selected personnel identity. It will be apparent to those of ordinary skill in the art in view of this disclosure that other dimensions of detailed credit information related to the selected personnel identity can be similarly provided. Each command option in command option area 3110 represents a different dimension of detailed credit information related to the selected personnel identity. In a particular example embodiment, command option 3112 (Credits') was selected by a user, which resulted in the detailed credits information being displayed in the information area 3120. It will be apparent to those of ordinary skill in the art in view of this disclosure that any of the other available command options in command option area 3110 can be similarly selected. As shown in FIG. 31, the user can manipulate the pointing device to position a selection box 3122 around or in proximity to any of the listed credits information items (different content items associated with the selected personnel identity). The user can select any of the listed credits information items by positioning the selection box 3122 around or near a desired credits information item and activating a selection button on a remote control device or other user platform signaling device. Upon selection of the desired credits information item by using selection box 3122, the Movie Overview page 3200 can be displayed as shown in FIG. 32.

Referring now to the example shown in FIG. 32, the sample content browsing and selection user interface includes Movie Overview page 3200, which can be displayed as a result of a user selection of desired credits information item 3122 from Credits page 3100. In this example, the desired credits information item 3122 corresponds to a different content item that is related to the selected personnel identity. The Movie Overview page 3200 represents yet another dimension (of a plurality of available dimensions) of detailed information related to a selected content item, in this example, the “12 Monkeys” movie, a selected personnel identity associated with the selected content item, in this example, ‘Bruce Willis’, and a different content item associated with the selected personnel identity, in this example, the movie ‘The Fifth Element’, starring Bruce Willis. Again, note that the detailed information (a different content item associated with the selected personnel identity, in this case) related to the selected content item is arranged hierarchically, relative to other detailed information associated with the selected content item. Also note that the Movie Overview page 3200 can also be accessed via the Movie Portal 2700 as described above. In the example of FIG. 32, Movie Overview page 3200 provides a detailed set of information related to the different content item in a content area 3220. Additionally, Movie Overview page 3200 provides a set of command options in a command option area 3210 for selecting among a set of dimensions of information corresponding to each of the command options. These dimensions of information enable a user to probe more deeply into a particular area of interest related to the selected different content item. For example, command option area 3210 can include command options such as: Overview, Synopsis, Review, Cast & Crew, Photos, Awards, Watch, and Similar. The Overview command presents an overview of information related to the selected different content item. A sample of such information is shown in content area 3220 of FIG. 32. The Overview information can include a synopsis of the different content item, an image, a list of the cast, rating and genre information, a user-selectable button 3222 to enable the user to watch, listen, or otherwise consume the different content item, and a user-selectable button 3224 to enable the user to bookmark the different content item for easy access. It will be apparent to those of ordinary skill in the art in view of this disclosure that a variety of additional information and command selections related to the particular content item can be equivalently provided. Additionally, advertising or other commercial content 3226 can be displayed in the content area 3220 to produce revenue when the content area 3220 is displayed to a user. Each of these command options in command option area 3210 can be selected by a user to obtain further information related to a different content item in a particular dimension. In this manner, the user can continue to explore the hierarchical dimensions of content information from a movie portal page provided via the Movie Portal 2700 as initiated through Root page 2600 shown in FIG. 26.

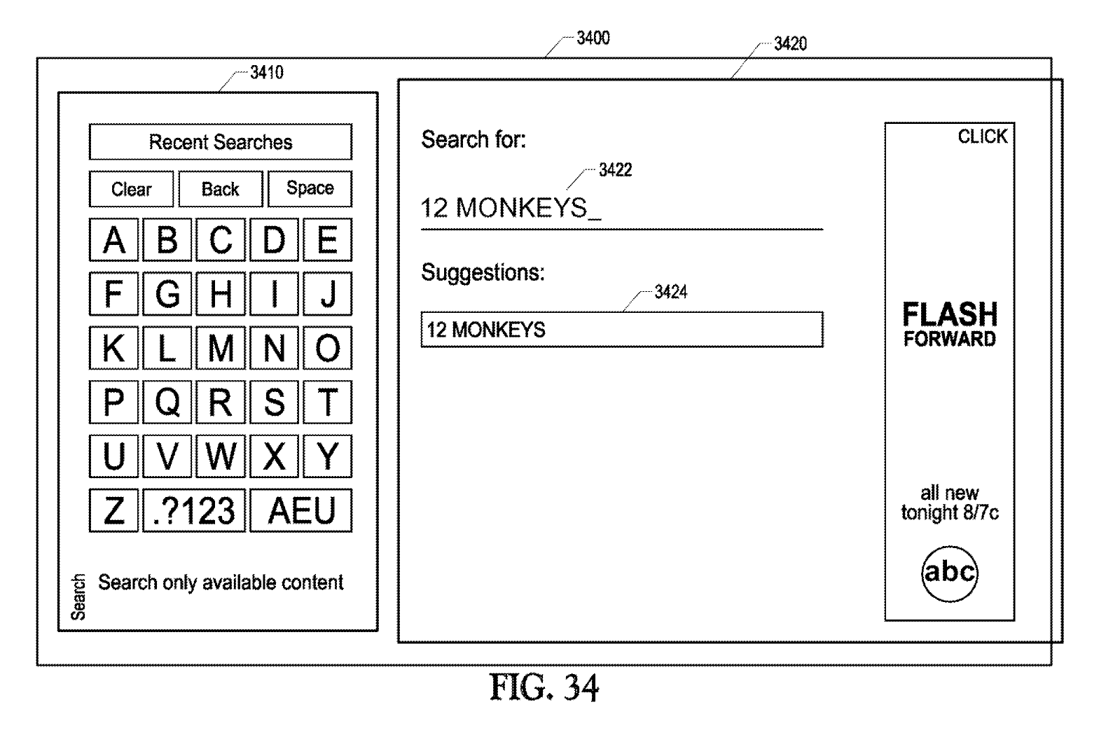

Referring now to the example shown in FIG. 33, the sample Root page 3300 is illustrated. In this example, the user has highlighted command option 1715 (Search') in command option area 1710 of the Root page 3300. The ‘Search’ command option enables the user to search for particular content items by using a user-generated search query. Upon selection of this command option, the Search page 3400 can be displayed as shown in FIG. 34.

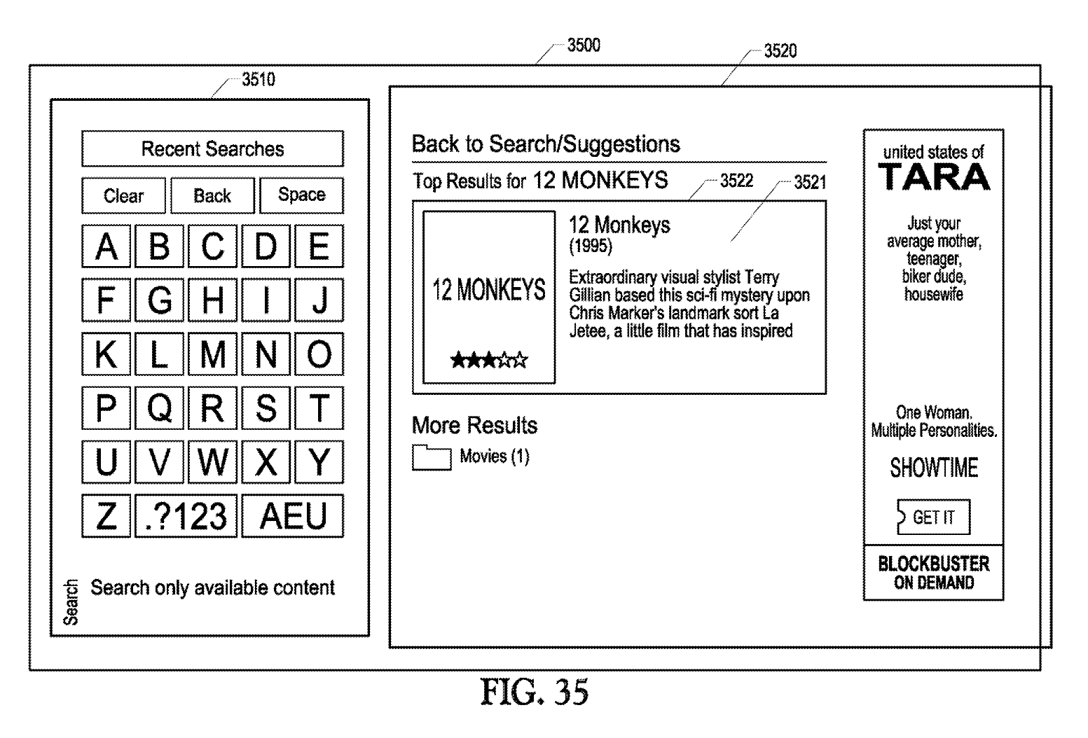

Referring now to the example shown in FIG. 34, the sample content browsing and selection user interface includes a Search page 3400 that can be presented to the user in response to the user selecting the ‘Search’ command option 1715 from Root page 3300. The Search page 3400 can also be accessed via the Listings page 1800 as describe above. Once the Search page 3400 is selected by the user, the user is presented with a palette of search tools, including an alphanumeric keyboard 3410, a search query entry field 3422, and a suggestion box 3424. The user can use the alphanumeric keyboard 3410 to compose a custom search query, which is transferred automatically to the search query entry field 3422 as the user types out characters of the search query. The search query can be keywords or phrases that can be matched to the content information associated with content items from a variety of content sources. For example, the user could type in the name of a television show, movie title, song title, actor name, and the like. As a user types in the search query, the content browsing and selection system of an embodiment can match the partial search query with content information associated with content items and suggest matching content items in the suggestion box 3424. In the example shown in FIG. 34, the user has entered the search query, “12 Monkeys” into the search query entry field 3422. The content browsing and selection system of an embodiment has matched the entered search query with content information associated with content items in database 112. As a result, the Search Results page 3500 shown in FIG. 35 is presented to the user along with the search results 3521 for the entered search query 3422. As shown in FIG. 35, the search results 3521 include a representation of each matching content item presented in the search results 3521. Each representation of a matching content item in the search results 3521 can include an image and/or a textual description of the particular content item. The search results 3521 can be listed in a manner similar to the content item listings in the Listings page 1800 described above or in the manner of the TV Portal 2000 of FIG. 20, or the Movie Portal 2700 of FIG. 27. Each of the content item representations in the search results 3521 is user selectable. As shown in FIG. 35, the user can manipulate the pointing device to position a selection box 3522 around any of the content item representations in the search results 3521. A slider bar (not shown) can be used to scroll the search results of any arbitrary length for viewing in the content item area 3520. The user can select any of the listed content item representations in the search results 3521 by positioning the selection box 3522 around a desired content item representation and activating a selection button on a remote control device or other user platform signaling device. Upon selection of the desired content item representation in the search results 3521 by using selection box 3522, the Movie Overview page 2800 can be displayed as shown in FIG. 28. For example, the user in the example of FIG. 35 has selected the movie content item representation, “12 Monkeys”. As a result, the Movie Overview page 2800 can be displayed as shown in FIG. 28 to provide additional dimensions of information and command options regarding the selected content item as explained in more detail above.

Referring again to FIG. 18, an example was shown in FIG. 18 and described above, wherein the user had selected command option ‘All’, which can be used to display all available listings in content listing area 1820. Alternatively, a user can use Listings page 1800 to select content from a content grouping represented by the ‘Sports’ command option in command option area 1810. The ‘Sports’ command option enables the user to pick content items from a group of broadcast, streamed, downloaded, or recorded sports programming options. In a manner similar to the functionality described above, the user can also view details of a selected sports personality, sports team, sports venue, sporting events, and the like. Command options are provided in a hierarchical set of pages with which a user can explore desired dimensions of detailed sports information in a succession of pages, such as the pages described above. Alternatively, a user can choose to select content from a content grouping represented by the ‘Kids’ command option in command option area 1810. The ‘Kids’ command option enables the user to pick content items from a group of broadcast, streamed, downloaded, or recorded programming options targeted for children. As described above, command options are provided in a hierarchical set of pages with which a user can explore desired dimensions of detailed children's programming information in a succession of pages. Alternatively, a user can choose to select content from a content grouping represented by the ‘News’ command option in command option area 1810. The ‘News’ command option enables the user to pick content items from a group of broadcast, streamed, downloaded, or recorded news programming options. As described above, command options are provided in a hierarchical set of pages with which a user can explore desired dimensions of detailed news information in a succession of pages. In an alternative embodiment, a user can choose to select content from a content grouping represented by an ‘HD Listings’ command option in command option area 1810. The ‘HD Listings’ command option enables the user to pick content items from a group of content options provided in high definition. Alternatively, a user can choose to select content from a content grouping represented by a ‘Favorites’ command option in command option area 1810. The ‘Favorites’ command option enables the user to pick content items from a group of programming options automatically determined as likely of interest to the user by the recommendation engine 241. As explained above, the recommendation engine 241 can automatically assemble a list of content items of likely interest to a particular user based on the user interest information. Additionally, a user can explicitly add content items to a Favorites group by using the bookmark command option as described above. Alternatively, a user can choose to select content from a content grouping represented by the ‘Calendar’ command option in command option area 1810. The ‘Calendar’ command option enables the user to pick content items based on a user-specified date/time parameter(s) from a calendar view. Alternatively, a user can choose to select for viewing a set of editorial information associated with content as represented by an ‘Editorial’command option in command option area 1810. The ‘Editorial’ command option enables the user to view editorial information related to a variety of content items or content groupings as previously gathered from a variety of editorial sources. Alternatively, a user can choose to view a listing of recommended content by using a ‘Recommended’ command option in command option area 1810. The ‘Recommended’ command option enables the user to view or browse recommended content items available for viewing and/or purchase from a variety of selectable content sources. In an example embodiment, the processing system 200 can use recommendation engine 241 to gather user interest information, as described above, and to correlate user interests with corresponding content items and content information retained or identified in the database 112. In this manner, processing system 200 can automatically assemble a list of recommended content items of likely interest to a particular user based on the user interest information. This list of recommended content items can be displayed for a user in response to selection of the ‘Recommended’ command option in command option area 1810. Additionally, the list of recommended content items can be sourced from an aggregation or combination of several content sources. In this manner, a user can view recommended content items without having to know where a particular content item is sourced. The user can also use various options provided within the ‘Recommended’ functionality to sort, filter, and group the recommended content items within the recommended content listing as desired.

In an alternative embodiment, the sample content browsing and selection Root page 1700 shown in FIG. 17 can include an option for a user to select an Internet content view presented to the user in response to the user selecting an ‘Internet’ command option from Root page 1700 shown in FIG. 17. In an example embodiment, the Internet content view can provide a variety of user-selectable Internet content items or website options in a content area 1720. In a particular embodiment, a content area 1720 can be configured similarly to a conventional web browser on a personal computer. Additionally, the Internet content view can provide a variety of Internet browsing-related command options in a command option area of an Internet content view. In this manner, a user can use the content browsing and selection user interface as described herein to browse the Internet in a novel manner, such as by using a television or another enabled user platform device that provides a large format or a smaller more portable format.

In alternative embodiments, other dimensions of information related to a selected content item can be made available to a user, each dimension being represented by selectable command options in command option areas as described herein. In this manner, the various embodiments enable a user to obtain many levels and/or degrees of detailed information and functionality related to many selected dimensions of detailed information related to a selected content item. For example, a user can select a command option, ‘Plot’ corresponding to a plot dimension associated with a selected content item. In an example embodiment, the plot dimension enables a user to obtain many levels of detailed information and functionality related to the plot of the selected content item. For example, the user can obtain a summary of the plot of the selected content item, obtain a list of other content items with a similar plot, obtain a list of other content items by the same writer and/or author, and watch, purchase, and/or rent a content item with a similar or related plot all via the content browsing and selection user interface provided in the various embodiments as described herein.

Similarly, a user can select a command option, ‘Music’ in a command option area corresponding to a music or audio dimension associated with a selected content item. In an example embodiment, the music or audio dimension enables a user to obtain many levels of detailed information and functionality related to the music or audio track of the selected content item. For example, the user can obtain a listing of the music and/or audio associated with the selected content item, obtain a list of other content items with a similar musical score and/or audio track, obtain a list of other content items having a musical score and/or audio track by the same musician, composer, and/or sound technician, and watch, purchase, and/or rent a content item with a similar or related musical score and/or audio track all via the content browsing and selection user interface provided in the various embodiments as described herein.

Similarly, a user can select a command option, ‘Review’ in a command option area corresponding to reviews associated with a selected content item. For example, see FIGS. 28, 29, and 32. In an example embodiment, the review dimension enables a user to obtain many levels of detailed information and functionality related to the published reviews of the selected content item. For example, the user can obtain a listing of the published reviews associated with the selected content item, obtain a list of other content items with similar reviews, a similar genre, or from a similar category, obtain a list of other content items having a review by the same reviewer, and watch, purchase, and/or rent a content item with a similar or related review, a similar genre, from a similar category, or from the same reviewer all via the content browsing and selection user interface provided in the various embodiments as described herein.

Referring again to FIGS. 21 and 28 in an example embodiment, a user can select a command option, ‘Photos’ in command option areas 2110 and 2810, respectively. For example, see FIGS. 29, 30, 31, and 32. The command option, ‘Photos’ enables a user to view corresponding photographs or images associated with a selected content item. In an example embodiment, the photos dimension enables a user to obtain many levels of detailed information and functionality related to the published photographs or images corresponding to the selected content item. For example, the user can obtain a list of the published photographs or images associated with the selected content item, obtain a list of other content items with similar photographs or images, obtain a list of other content items having photographs or images by the same photographer, animator, illustrator, or graphic artist, and watch, purchase, and/or rent a content item with a similar or related photographs or images, or from the same photographer, animator, illustrator, or graphic artist all via the content browsing and selection user interface provided in the various embodiments as described herein.

Referring again to FIGS. 21 and 28 in an example embodiment, a user can select a command option, ‘Similar’ in command option areas 2110 and 2810, respectively. The command option, ‘Similar’ enables a user to view other content related to a selected content item. In an example embodiment, the similar content dimension enables a user to obtain many levels of detailed information and functionality related to other content related to the selected content item. For example, the user can obtain a list of other content items related to the selected content item, obtain a list of other content items with a similar genre or from a similar category, rating, ranking, date, etc., and watch, purchase, and/or rent a related content item all via the content browsing and selection user interface provided in the various embodiments.

Referring again to FIGS. 21 and 28 in an example embodiment, a user can select a command option, ‘Awards’ in command option areas 2110 and 2810, respectively. The command option, ‘Awards’ enables a user to view awards or certifications associated with a selected content item. In an example embodiment, the awards dimension enables a user to obtain many levels of detailed information and functionality related to the awards or certifications corresponding to the selected content item. For example, the user can obtain a list of the awards or certifications associated with the selected content item, obtain a list of other content items with similar awards or certifications, and watch, purchase, and/or rent a content item with a similar or related award or certification all via the content browsing and selection user interface provided in the various embodiments as described herein. It will be apparent to those of ordinary skill in the art in view of this disclosure that a variety of other content information dimensions associated with a selected content item can be similarly provided by using the functionality described herein.

Referring now to FIGS. 36 through 38, a flow of user interface pages are shown to illustrate a sequence of sample user operations. For example, as shown in FIG. 36, a user can start a sequence of content search or browse operations at Root page 1700 as described above. Using the various command options provided in the Root page 1700, the user can choose to access content Listings 1800, the TV Portal 2000, the Movie Portal 2700, or the Search page 3400. The following user actions in each of these sequences can lead to the subsequent page displays as shown in FIG. 36 and described above. Additionally, the user can interrupt any of these sequences and return to the Root page 1700 to start a new sequence. Additionally, the user can enter the Listings 1800, the TV Portal 2000, the Movie Portal 2700, or the Search page 3400 sequences from any of the other sequences. As such, the user can jump between any of the functional sequences as desired to quickly obtain desired content or content information in a desired dimension and/or at a desired degree of detail.

FIG. 37 illustrates the content listing functionality provided via the Listings page 1800 of an example embodiment. As shown, the Listings page 1800 can be used to browse and access a variety of different types of content and content information, including TV content and TV content information (pages 2100 through 2500, for an example), movie content and movie content information (pages 2800 through 3200, for an example), news content, sports content, kids content, favorite content, personal content, and other content. In each case, the sequences of pages presented to a user can be implemented as described above. The user can use the Listings page 1800 and the subsequent sequences of pages for access to various dimensions of content information and for access to the content itself for viewing, listening, reading, or otherwise consuming the content. At any stage, the user can return to the Root page 1700 or jump to any of the functional sequences as desired to quickly obtain desired content or content information in a desired dimension and/or at a desired degree of detail.

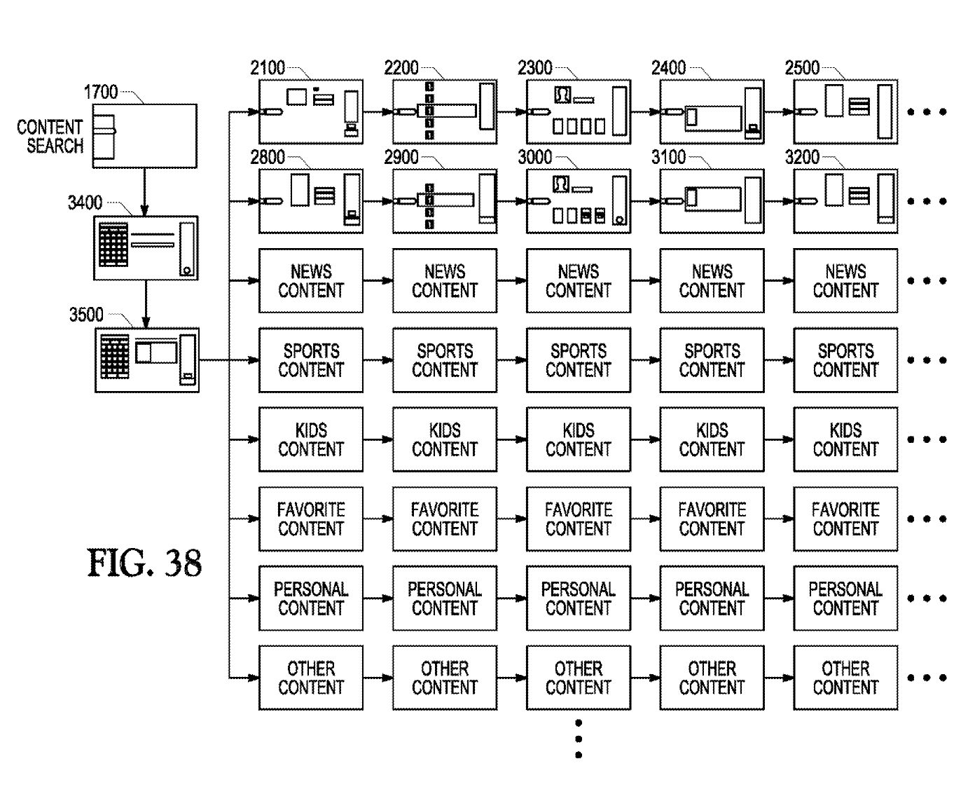

FIG. 38 illustrates the content searching functionality provided via the Search page 3400 of an example embodiment. As shown, the Search page 3400 can be used to search and access a variety of different types of content and content information, including TV content and TV content information (pages 2100 through 2500, for an example), movie content and movie content information (pages 2800 through 3200, for an example), news content, sports content, kids content, favorite content, personal content, and other content. In each case, the sequences of pages presented to a user can be implemented as described above. In a manner similar to the Listings page 1800, the user can use the Search page 3400 and the subsequent sequences of pages for access to various dimensions of content information and for access to the content itself for viewing, listening, reading, or otherwise consuming the content. At any stage, the user can return to the Root page 1700 or jump to any of the functional sequences as desired to quickly obtain desired content or content information in a desired dimension and/or at a desired degree of detail.

Thus, the content browsing and selection user interface provided in various embodiments herein improves the user's capabilities for content browsing, searching, and selection of digital content items and related content information in a variety of hierarchical dimensions.

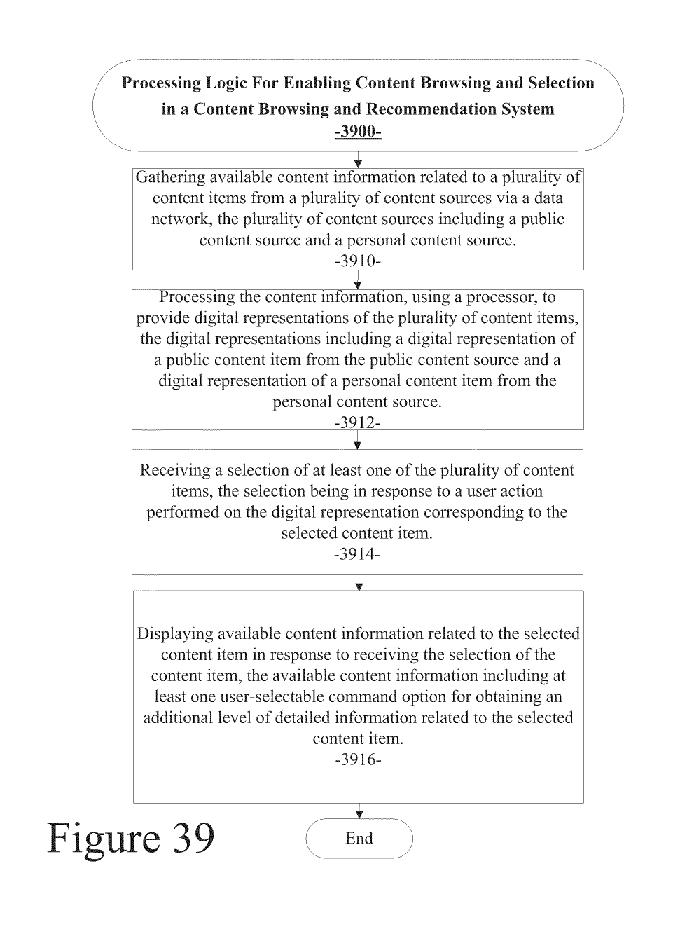

FIG. 39 illustrates a sequence of processing operations in an example embodiment. As shown in FIG. 39, the processing operations performed by an example embodiment 3900 at a user platform include: gathering available content information related to a plurality of content items from a plurality of content sources via a data network, the plurality of content sources including a public content source and a personal content source, at processing block 3910; processing the content information, using a processor, to provide digital representations of the plurality of content items, the digital representations including a digital representation of a public content item from the public content source and a digital representation of a personal content item from the personal content source, at processing block 3912; receiving a selection of at least one of the plurality of content items, the selection being in response to a user action performed on the digital representation corresponding to the selected content item, at processing block 3914; and displaying available content information related to the selected content item in response to receiving the selection of the content item, the available content information including at least one user-selectable command option for obtaining an additional level of detailed information related to the selected content item, at processing block 3916. The detailed information has a relevance to at least one of: (1) a user selection, indication, and/or preference; (2) a prior selected, browsed, and/or searched content item and/or content information; and/or (3) a currently presented or consumed content item and/or content information.

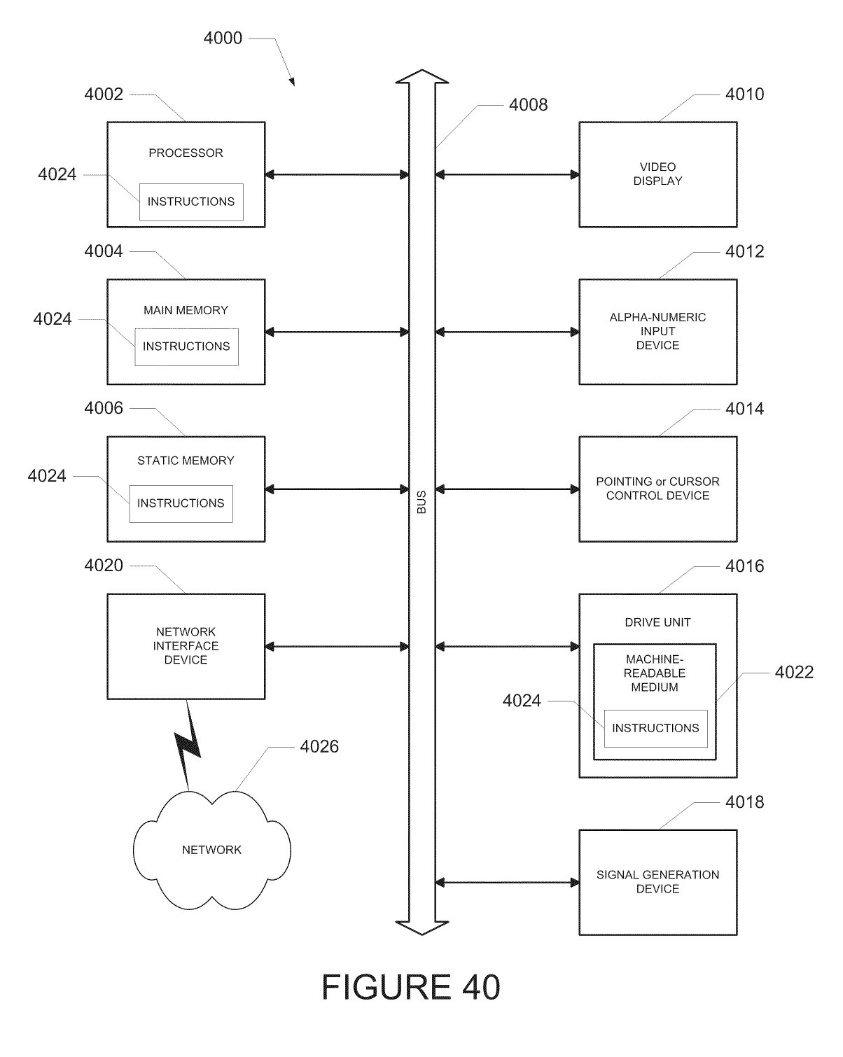

FIG. 40 shows a diagrammatic representation of a machine in the example form of a computer system 4000 within which a set of instructions, for causing the machine to perform any one or more of the methodologies discussed herein, may be executed. In alternative embodiments, the machine operates as a standalone device or may be coupled, e.g., networked, to other machines. In a networked deployment, the machine may operate in the capacity of a server or a client machine in client-server network environment, or as a peer machine in a peer-to-peer and/or distributed network environment. The machine may be a server computer, a client computer, a personal computer (PC), a tablet PC, a set-top box (STB), a Personal Digital Assistant (PDA), a cellular telephone, a web appliance, an audio or video player, a network router, switch or bridge, or any machine capable of executing a set of instructions, sequential or otherwise, that specify actions to be taken by that machine. Further, while a single machine is illustrated, the term “machine” shall also be taken to include any collection of machines that individually or jointly execute a set, or multiple sets, of instructions to perform any one or more of the methodologies discussed herein.

The example computer system 4000 includes a data processor 4002, e.g., a central processing unit (CPU), a graphics processing unit (GPU), or both, a main memory 4004 and a static memory 4006, which communicate with each other via a bus 4008. The computer system 4000 may further include a video display unit 4010, e.g., a liquid crystal display (LCD), a cathode ray tube (CRT), or other imaging technology. The computer system 4000 also includes an input device 4012, e.g., a keyboard, a pointing device or cursor control device 4014, e.g., a mouse, a disk drive unit 4016, a signal generation device 4018, e.g., a speaker, and a network interface device 4020.

The disk drive unit 4016 includes a non-transitory machine-readable medium 4022 on which is stored one or more sets of instructions and data, e.g., software 4024, embodying any one or more of the methodologies or functions described herein. The instructions 4024 may also reside, completely or at least partially, within the main memory 4004, the static memory 4006, and/or within the processor 4002 during execution thereof by the computer system 4000. The main memory 4004 and the processor 4002 also may constitute machine-readable media. The instructions 4024 may further be transmitted or received over a network 4026 via the network interface device 4020.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system, e.g., a standalone, client or server computer system, configured by an application may constitute a “module” that is configured and operates to perform certain operations as described herein. In other embodiments, the “module” may be implemented mechanically or electronically. For example, a module may comprise dedicated circuitry or logic that is permanently configured, e.g., within a special-purpose processor, to perform certain operations. A module may also comprise programmable logic or circuitry, e.g., as encompassed within a general-purpose processor or other programmable processor, that is temporarily configured by software to perform certain operations. It will be appreciated that the decision to implement a module mechanically, in the dedicated and permanently configured circuitry, or in temporarily configured circuitry, e.g. configured by software, may be driven by cost and time considerations. Accordingly, the term “module” should be understood to encompass an entity that is physically or logically constructed, permanently configured, e.g., hardwired, or temporarily configured, e.g., programmed, to operate in a certain manner and/or to perform certain operations described herein. While the machine-readable medium 4022 is shown in an example embodiment to be a single medium, the term “machine-readable medium” should be taken to include a single medium or multiple media, e.g., a centralized or distributed database, and/or associated caches and servers that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical media, and/or magnetic media. As noted, the software may be transmitted over a network by using a transmission medium. The term “transmission medium” shall be taken to include any non-transitory medium that is capable of storing, encoding or carrying instructions for transmission to and execution by the machine, and includes digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

The system of an example embodiment may include software, information processing hardware, and various processing steps, which are described herein. The features and process steps of example embodiments may be embodied in articles of manufacture as machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and system described herein is equally applicable to other network infrastructures or other data communications systems.

Various embodiments are described herein. In particular, the use of embodiments with various types and formats of user interface presentations and/or application programming interfaces may be described. It can be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

Thus, a computer-implemented system and method for providing a user interface for content browsing and selection in a content system are disclosed. While the present invention has been described in terms of several example embodiments, those of ordinary skill in the art can recognize that the present invention is not limited to the embodiments described, but can be practiced with modification and alteration within the spirit and scope of the appended claims. The description herein is thus to be regarded as illustrative instead of limiting.

What is claimed is:

1. A computer-implemented method comprising:
gathering available content information related to a plurality of content items from a plurality of content sources via a data network, the plurality of content sources including a public content source and a personal content source;
processing the content information, using a processor, to provide digital representations of the plurality of content items, the digital representations including a digital representation of a public content item from the public content source and a digital representation of a personal content item from the personal content source;
receiving a selection of at least one of the plurality of content items, the selection being in response to a user action performed on the digital representation corresponding to the selected content item; and
displaying available content information related to the selected content item in response to receiving the selection of the content item, the available content information including at least one user-selectable command option for obtaining an additional level of detailed information related to the selected content item.

2. The computer-implemented method of claim 1 including enabling a user to select a second content item that is related to the selected content item based on the displayed content information.

3. The computer-implemented method of claim 1 wherein the displayed content information includes detailed information on personnel related to the selected content item.

4. The computer-implemented method of claim 1 wherein the displayed content information includes detailed information on similar content related to the selected content item.

5. The computer-implemented method of claim 1 wherein the displayed content information includes detailed information on music or audio related to the selected content item.

6. The computer-implemented method of claim 1 including processing the content information by extracting metadata from the content information.

7. The computer-implemented method of claim 1 wherein the selected content item is of a type from the group: movie content, television content, personal content, and internet content.

8. The computer-implemented method of claim 1 wherein the displayed content information including a digital representation of a cover design corresponding to a physical media of the selected content item.

9. The computer-implemented method of claim 1 including providing a user interface object to enable a user to receive a recommendation of other content related to the selected content item.

10. The computer-implemented method of claim 1 including delivering a selected content item to a user platform of a user.

11. A system comprising:
one or more data processors;
a data network interface in communication with the one or more data processors;
a database for storing processed content information and accessible to the one or more data processors;
a user interface component having a data network interface, the user interface component being executable by the one or more data processors to:
gather available content information related to a plurality of content items from a plurality of content sources via a data network, the plurality of content sources including a public content source and a personal content source;
process the content information to provide digital representations of the plurality of content items, the digital representations including a digital representation of a public content item from the public content source and a digital representation of a personal content item from the personal content source;
receive a selection of at least one of the plurality of content items, the selection being in response to a user action performed on the digital representation corresponding to the selected content item; and
display available content information related to the selected content item in response to receiving the selection of the content item, the available content information including at least one user-selectable command option for obtaining an additional level of detailed information related to the selected content item.

12. The system of claim 11 being configured to enable a user to select a second content item that is related to the selected content item based on the displayed content information.

13. The system of claim 11 wherein the displayed content information includes detailed information on personnel related to the selected content item.

14. The system of claim 11 wherein the displayed content information includes detailed information on similar content related to the selected content item.

15. The system of claim 11 wherein the displayed content information includes detailed information on music or audio related to the selected content item.

16. The system of claim 11 being configured to process the content information by extracting metadata from the content information.

17. The system of claim 11 wherein the selected content item is of a type from the group: movie content, television content, personal content, internet content.

18. The system of claim 11 wherein the displayed content information including a digital representation of a cover design corresponding to a physical media of the selected content item.

19. The system of claim 11 being configured to provide a user interface object to enable a user to receive a recommendation of other content related to the selected content item.

20. The system of claim 11 wherein the user interface component being configured to deliver a selected content item to a user platform of a user.

21. An article of manufacture comprising a non-transitory machine-readable storage medium having machine executable instructions embedded thereon, which when executed by a machine, cause the machine to:
gather available content information related to a plurality of content items from a plurality of content sources via a data network, the plurality of content sources including a public content source and a personal content source;
process the content information to provide digital representations of the plurality of content items, the digital representations including a digital representation of a public content item from the public content source and a digital representation of a personal content item from the personal content source;
receive a selection of at least one of the plurality of content items, the selection being in response to a user action performed on the digital representation corresponding to the selected content item; and
display available content information related to the selected content item in response to receiving the selection of the content item, the available content information including at least one user-selectable command option for obtaining an additional level of detailed information related to the selected content item.

22. A user platform with a data network interface, the user platform comprising:
a content information cache; and
a user interface component being executable by one or more data processors to:
gather available content information related to a plurality of content items from a plurality of content sources via a data network, the plurality of content sources including a public content source and a personal content source;
process the content information to provide digital representations of the plurality of content items, the digital representations including a digital representation of a public content item from the public content source and a digital representation of a personal content item from the personal content source;
receive a selection of at least one of the plurality of content items, the selection being in response to a user action performed on the digital representation corresponding to the selected content item; and
display available content information related to the selected content item in response to receiving the selection of the content item, the available content information including at least one user-selectable command option for obtaining an additional level of detailed information related to the selected content item.
